(19) United States
(12) Patent Application Publication
(10) Pub. No.: US 2024/0202636 A1
(43) Pub. Date: Jun. 20, 2024

(54) PRODUCTIVITY METER OF A CONFERENCE CALL

(71) Applicant: Avaya Management L.P., Durham, NC (US)

(72) Inventors: Navin Daga, Silapathar (IN); Pushkar Deole, Karvenagar (IN); Sandesh Chopdekar, Kondhwa (IN)

(21) Appl. No.: 18/066,180

(22) Filed: Dec. 14, 2022

(51) Int. Cl. G06Q 10/0639; H04L 12/18

(52) U.S. Cl. CPC G06Q 10/06393; H04L 12/1818; H04L 12/1822

(57) ABSTRACT

A method for generating a productivity score for a communication session is provided. The method includes identifying one or more meeting parameters during the communication session with a plurality of participants, providing the one or more identified meeting parameters to a machine learning network and receiving an output from the machine learning network in response to the machine learning network processing the one or more identified meeting parameters. The output incudes a productivity score generated in real-time for the communication session based on the one or more identified meeting parameters and the output is determined based on a comparison between the identified meeting parameters and corresponding scheduled meeting parameters. The method also includes, in response to a final productivity score exceeding or failing to meet a threshold value, adjusting a duration of the communication session.

### FIELD

Embodiments of the present disclosure relate generally to communication systems and methods and specifically to communication systems and methods for measuring the productivity of communication sessions and using the measured productivity to improve future communication sessions.

### BACKGROUND

Communication sessions such as conference calls for conducting meetings have become the new normal. As an increasing number of conference calls are being implemented in different sectors of various industries to conduct business, challenges arise when multiple participants are on the call. One challenge, for example, is determining the productivity of the call itself (e.g., was the call beneficial or did the call achieve its goal) based on how the call was conducted. Another challenge is determining the productivity of each individual participant to the call. Without proper analysis of the productivity of the conference call, future conference calls will remain unproductive.

### BRIEF SUMMARY

Thus, there is a need for a productivity engine that provides a productivity score for communication sessions. According to embodiments of the present disclosure, the productivity engine or productivity meter of a communication session that analyzes the communication session is provided. Moreover, according to one embodiment of the present disclosure, productivity metering is performed in real-time. According to an alternative embodiment of the present disclosure, productivity metering is performed post completion of the communication session and reoccurring trends in communication sessions are also analyzed. Moreover, according to a further embodiment of the present disclosure, productivity metering is performed both in real-time and after completion of the communication session.

According to embodiments of the present disclosure, the productivity meter utilizes artificial intelligence (AI) and/or machine learning to gather data to include some or all components of the data to provide an analysis of what works and what needs improvement during a communication session. Accordingly, the following features can be analyzed during a communication session: (1) how much time was spent on a meeting agenda and/or each topic in the meeting agenda; (2) the time lost due to participants joining the communication session late; (3) the time wasted because the right participants were not present during the communication session; (4) the time lost due to connectivity issues regarding the communication session, etc.

According to embodiments of the present disclosure, the productivity meter compares trends of previous communication sessions and determines if the productivity of a present communication session is above or below average with respect to the previous communication sessions having similar meeting parameters and/or meeting conditions. As defined herein, meeting parameters may include at least time meeting parameters, location meeting parameters, participant meeting parameters and topic meeting parameters. The time meeting parameters include the date, the day, the hour, the duration, the frequency of a meeting or a communication session, etc. The location meeting parameters include information regarding the place of the meeting or communication session and/or whether the meeting or communication session was conducted locally or remotely. The participant meeting parameters may include the identification of the participants to the communication session, the title of the participants, the participation level of the participants, etc. The topic meeting parameters may include topics to be discussed during the communication session. The meeting conditions may include connectivity issues regarding the communication session, for example.

The productivity meter can provide an indication as to how much was achieved (e.g., productivity) during a communication session versus what was scheduled to be achieved based on the agenda. Therefore, the productivity meter can generate a score of more than 100% in some cases where what was achieved during the communication session is greater than what was scheduled to be achieved based on the agenda. According to embodiments of the present disclosure, the productivity meter can determine which day of the week productivity is better (e.g., the start of the week versus the middle of the week versus the end of the week). The productivity meter can also compare meeting parameters and/or meeting conditions with trends for similar calls in an organization and provide participants on one team with an idea of how participants on other teams of the organization fare with respect to each other.

As such, the productivity meter can assist an organization in improving productivity among teams and team members. For example, in a typical bug (e.g., issue(s) raised by a customer) scrub (the handling or addressing of the issue(s) raised by the customer), the trend is to spend an average of X minutes for a particular category of a bug, whereas other team members are spending Y minutes to handle the same category of the bug. Contributing factors for this disparity in time include one or more team members being unprepared and/or the team or team members not correctly categorizing the bug. For a regular bug/feature/task review meeting, for example, the productivity meter according to an embodiment of the present disclosure, determines that the meeting should be planned at the beginning, in the middle or at the end of a week, a month, a season, or a year, for example. For recurring calls, the productivity meter according to embodiments of the present disclosure, determines trends and provides possible solutions to increase productivity. Accordingly, some of the provided solutions include the following: (1) the time of the call is not suitable to all the participants which leads to delays, absentees, etc. and (2) the productivity is better if the call is held in the morning versus in the afternoon.

According to embodiments of the present disclosure, the productivity meter can also determine where the unproductive time is being spent. For example, the productivity meter can determine whether an appropriate audience not invited/present or whether the participants were unprepared. The productivity engine can be programmed or trained to categorize different types of calls based on machine learning algorithms and user feedback by evaluating similar calls across the organization.

According to embodiments of the present disclosure, the productivity meter provides a quantitative analysis for communication sessions. Nonlimiting examples of quantitative analysis include the following: (1) analyze how many topics of the agenda are to be discussed during the meeting and the total time allocated for the meeting; (2) the time taken to discuss each of the topics of the agenda and what type of conclusion, if any, was reached (e.g., a conclusion was reached too early, no conclusion was reached after a long period of discussion, no conclusion was reached and the participants provided statements or comments such as “need to have a follow-up meeting” or “need a separate meeting to discuss this”, etc.; (3) the number of meetings for the same topic/issue or the same topic/issue discussed in different calls—if the same topic/issue is discussed in different calls, the productivity meter could also recommend merging the calls; and (4) for a bug scrub, the number of bugs discussed on each call and the type of bugs discussed—for example, X P1 issues discussed, Y P2 discussed, etc.

According to embodiments of the present disclosure, the productivity meter also provides comments, recommendations, suggestions, and/or additional information regarding the qualitative analysis for the communication sessions. Nonlimiting examples of the comments, recommendations, suggestions, and/or additional information for the qualitative analysis include the following: (1) how the meeting ended: were there indications that it was good conversation, a good discussion, a healthy discussion, more such meetings should take place, etc. provided by the participants to the communication session or other team members; (2) the overall sentiment of the meeting: too many back and forth arguments or the participants are in agreement with each other, etc.; (3) suggested follow up—the agenda was not completed; (4) the scope of the discussion changed during the meeting; (5) a point discussed during the meeting which rendered the entire agenda irrelevant; (6) the meeting outcome suggests that a separate discussion/clarity on another item was required before a topic of interest could be discussed; (7) repetition: the same topics discussed multiple times or repeated to the audience; and (8) in case of scrums, a determination made as to whether or not the participants are staying point to point and taking discussions offline or ending up with discussions on the scrum itself. As defined herein, a scrum is an agile methodology for project management. Generally, in a corporate setting, there is a daily scrum call which is meant to be a quick 15-minute call. There are usually three points of focus for a scrum call: (1) what you achieved since the last meeting; (2) what you plan to do till the next meeting and (3) any impediments. For such scrum calls, productivity should be determined based on if an individual sticks to the agenda of the three points identified above and not solving problems on the call. Solving problems on the call creates distractions and is a waste of time for participants to the call.

According to embodiments of the present disclosure, the productivity meter calculates a productivity score using a machine learning model and provides the productivity score along with recommendations for increasing the productivity score. The productivity score is calculated differently for different types of calls, meetings, discussions, communication sessions, etc. For example, a general discussion call might move in different directions whereas a focused/agenda-based discussion call usually adheres to the agenda. Subsequently the focused/agenda-based discussion call would score higher than the general discussion call. Data models associated with the productivity meter are trained to learn from similar calls of other teams across an organization to predict the productivity score. The data models are further trained to adapt to a user's preferences to generate the productivity score. For example, a meeting host may like to spend the first five minutes of a communication session discussing topics unrelated to scheduled meeting topics. Accordingly, the productivity engine learns from user feedback and tunes to the user preferences to remove the first five minutes of the communication session for productivity evaluation purposes.

In certain embodiments of the present disclosure, data mining and machine learning tools and techniques may be used in the methods and systems disclosed herein. The data mining and machine learning tools and techniques may determine outcomes of meetings and provide a score regarding the productivity of the meetings. The productivity score may be compared to threshold values to categories and/or rank the meeting and/or determine trends. Any of the information regarding the productivity scores may be modified and act as feedback to the system.

These and other needs are addressed by the various embodiments and configurations of the present disclosure. The present disclosure can provide a number of advantages depending on the particular configuration. These and other advantages will be apparent from the disclosure contained herein.

Embodiments of the present disclosure include a method for generating a productivity score for a communication session including identifying, by a processor, one or more meeting parameters during a communication session with a plurality of participants, providing, by the processor, the one or more identified meeting parameters to a machine learning network and receiving, by the processor, an output from the machine learning network in response to the machine learning network processing the one or more identified meeting parameters. The output includes a productivity score generated in real-time for the communication session based on the one or more identified meeting parameters and the output is determined based on a comparison between the identified meeting parameters and corresponding scheduled meeting parameters. The method also includes in response to a final productivity score exceeding or failing to meet a threshold value, adjusting, by the processor, a duration of the communication session.

Aspects of the above method include wherein the one or more identified meeting parameters are selected from the group consisting of time meeting parameters, location meeting parameters, participant meeting parameters and topic meeting parameters.

Aspects of the above method include generating, by the processor, a productivity score for each of the one or more identified meeting parameters, wherein the productivity score is further based on the machine learning network learning from user feedback and tuning the productivity score based on the user feedback.

Aspects of the above method include outputting, by the processor, a notification to a user device of one or more of the plurality of participants based on a participant meeting parameter productivity score.

Aspects of the above method include wherein the output is further determined based on a comparison between the identified meeting parameters and meeting parameters from previous communication sessions.

Aspects of the above method include wherein the notification includes transmitting a message to the user device of the one or more of the plurality of participants.

Aspects of the above method include outputting, by the processor, to the user device of the one or more of the plurality of participants, a graphical user interface representation of the communication session with representations for the plurality of participants based on the participant meeting parameter productivity score.

Aspects of the above method include adjusting, by the processor, a size of one or more of the representations for the plurality of participants based on an adjusted participant parameter productivity score.

Aspects of the above method include highlighting, by the processor, one or more of the representations for the plurality of participants based on an adjusted participant parameter productivity score.

Aspects of the above method include including, by the processor, a visual representation of the participant parameter productivity scores for each of the plurality of participants along with the representations for the plurality of participants.

Aspects of the above method include outputting, by the processor, the final productivity score to a user device of one or more of the plurality of participants.

Aspects of the above method include outputting, by the processor, a recommendation regarding the communication session along with the productivity score to the user device of one or more of the plurality of participants.

Aspects of the above method include dynamically scheduling, by the processor, a subsequent communication session based on the final productivity score failing to meet the threshold value.

Aspects of the above method include dynamically adding or deleting, by the processor, participants to a future communication session, based on the final productivity score exceeding or failing to meet a threshold value.

Embodiments of the present disclosure include a system including one or more processors and a memory coupled with and readable by the one or more processors having stored therein a set of instructions which, when executed by the one or more processors, causes the one or more processors to generate a productivity score for a communication session by: identifying one or more meeting parameters during a communication session with a plurality of participants, providing the one or more identified meeting parameters to a machine learning network and receiving an output from the machine learning network in response to the machine learning network processing the one or more identified meeting parameters. The output includes a productivity score generated in real-time for the communication session based on the one or more identified meeting parameters and the output is determined based on a comparison between the identified meeting parameters and corresponding scheduled meeting parameters. The one or more processors are also caused to generate the productivity score for the communication session by, in response to a final productivity score exceeding or failing to meet a threshold value, adjusting a duration of the communication session.

Aspects of the above system include wherein the one or more identified meeting parameters are selected from the group consisting of time meeting parameters, location meeting parameters, participant meeting parameters and topic meeting parameters.

Aspects of the above system include wherein the output is further determined based on a comparison between the identified meeting parameters and meeting parameters from previous communication sessions.

Embodiments of the present disclosure include a computer-readable storage medium including a set of instructions stored therein which, when executed by one or more processors, causes the one or more processors to generate a productivity score for a communication session by: identifying one or more meeting parameters during a communication session with a plurality of participants, providing the one or more identified meeting parameters to a machine learning network and receiving an output from the machine learning network in response to the machine learning network processing the one or more identified meeting parameters. The output comprises a productivity score generated in real-time for the communication session based on the one or more identified meeting parameters and the output is determined based on a comparison between the identified meeting parameters and corresponding scheduled meeting parameters. The one or more processors are further caused to generate the productivity score for the communication session by in response to a final productivity score exceeding or failing to meet a threshold value, adjusting a duration of the communication session.

Aspects of the above computer-readable storage medium include wherein the one or more identified meeting parameters are selected from the group consisting of time meeting parameters, location meeting parameters, participant meeting parameters and topic meeting parameters.

Aspects of the above computer-readable storage medium include wherein the output is further determined based on a comparison between the identified meeting parameters and meeting parameters from previous communication sessions.

The present disclosure provides a number of advantages over the prior art. For example, the selection or training of machine learning models results in improved speed or accuracy, or the ability of a computer to perform a function it could not previously perform. Also, the generation or filtering of training data results in models that require fewer computer resources or increase processing speed. Moreover, the identification of salient parameters, features or thresholds that are more important to decision making than others, which improve the processing speed or reduce network latency of artificial intelligence technology. As such, being able to determine the productivity of a communication session in real-time is clearly something that cannot be done practically using a mental process. Instead, the productivity determination processes described herein will only work practically in a computerized environment.

As used herein, information may include data, including various types of communications and/or messages that are multiple electronic records, text, rich media, or data structures. Communications may be data that is stored on a storage/memory device, and/or transmitted from one communication device to another communication device via a communication network. A message may be transmitted via one or more data packets and the formatting of such data packets may depend upon the messaging protocol used for transmitting the electronic records over the communication network. Information may contain different types of information, which is also referred to as content and data herein.

As used herein, a data model may correspond to a data set that is useable in an artificial neural network and that has been trained by one or more data sets that describe conversations or message exchanges between two or more entities. The data model may be stored as a model data file or any other data structure that is useable within a neural network or an Artificial Intelligence (AI) system. As used herein, AI can refer to an artificial neural network that has been trained to perform certain actions. The training may make use of a data set that describes initial data used to train the system. AI can be referred to as machine learning.

As used herein, a communication or a communication session may also be referred to as an “engagement,” a “message,” and a “communication session” and may include one or multiple electronic records, text, rich media, or data structures that are transmitted from one communication device to another communication device via a communication network. A communication may be transmitted via one or more data packets and the formatting of such data packets may depend upon the messaging protocol used for transmitting the electronic records over the communication network.

As used herein, the term “action” refers to various types of actions, including but not limited to processing information using processing input to obtain processing decisions as described herein, configuring/forwarding/sending one or more communications, displaying information, determining additional related information and actions to perform, monitoring for matching information, including key words and/or repeated content, monitoring activity of one or more users and/or groups, determining topics and related information (e.g., pieces of content), and interacting with databases. Unless described otherwise herein, actions of portions thereof may be executed automatically, e.g., without human involvement.

As used herein, the term “manage” refers to actions taken to control or direct elements. The term manage includes, and is not limited to, creating, implementing, performing, comparing, configuring, updating, revising, editing, changing, processing, deleting, saving, displaying, transmitting, transcribing, and otherwise implementing changes and controlling elements.

As used herein, AI can refer to an artificial neural network that has been trained to perform certain actions. The training may make use of a data set that describes initial data used to train the system. AI can be referred to as machine learning.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “including” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to email or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “analyze,” “process,” “calculate,” and “compute,” and variations thereof, as used herein, are used interchangeably, and include any type of methodology, process, mathematical operation or technique.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Illustrative hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Methods described or claimed herein can be performed with traditional executable instruction sets that are finite and operate on a fixed set of inputs to provide one or more defined outputs. Alternatively, or additionally, methods described or claimed herein can be performed using AI, machine learning, neural networks, or the like. In other words, a system or contact center is contemplated to include finite instruction sets and/or artificial intelligence-based models/neural networks to perform some or all of the steps described herein.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram illustrating a system that supports measuring the productivity of communication sessions and using the measured productivity to improve future communication sessions in accordance with at least some embodiments of the present disclosure;

FIG. 2A is a block diagram illustrating a system that supports measuring the productivity of communication sessions and using the measured productivity to improve future communication sessions in accordance with at least some embodiments of the present disclosure;

FIG. 2B is a block diagram illustrating a productivity server that supports measuring the productivity of communication sessions and using the measured productivity to improve future communication sessions in accordance with at least some embodiments of the present disclosure;

FIG. 3 is a block diagram illustrating a productivity engine of a productivity server that supports measuring the productivity of communication sessions and using the measured productivity to improve future communication sessions in accordance with at least some embodiments of the present disclosure;

FIGS. 4A and 4B are block diagrams illustrating example communication session user interfaces in accordance with at least some embodiments of the present disclosure;

FIGS. 4C and 4D are block diagrams illustrating alternative example communication session user interfaces in accordance with at least some embodiments of the present disclosure;

FIG. 5 is a block diagram illustrating an example communication session user interface screenshot in accordance with at least some embodiments of the present disclosure;

FIG. 6 is a block diagram illustrating an example communication session user interface screenshot in accordance with at least some embodiments of the present disclosure;

FIG. 7 is a block diagram illustrating an example communication session user interface screenshot for productivity data in accordance with at least some embodiments of the present disclosure;

FIG. 8 is a block diagram illustrating an example communication session user interface screenshot for productivity activation in accordance with at least some embodiments of the present disclosure;

FIG. 9 is a block diagram illustrating an example communication session user interface screenshot for productivity activation in accordance with at least some embodiments of the present disclosure;

FIG. 10 is a diagram illustrating an example communication session user interface for scheduling an agenda for a communication session and having previous meeting statistics available, in accordance with at least some embodiments of the present disclosure;

FIG. 11 is a diagram illustrating an example communication session user interface for recording the amount of time spent on topics within a meeting, in accordance with at least some embodiments of the present disclosure;

FIG. 12 is a diagram illustrating an example communication session user interface for rescheduling incomplete topics from a meeting, in accordance with at least some embodiments of the present disclosure;

FIG. 13 is a diagram illustrating an example communication session user interface for displaying to a user the current progress of a meeting, in accordance with at least some embodiments of the present disclosure;

FIG. 14 is a diagram illustrating an example communication session user interface for applying additional features to meeting topics, in accordance with at least some embodiments of the present disclosure;

FIG. 15 is a flowchart of an example process for measuring the productivity of communication sessions and using the measured productivity to improve future communication sessions in accordance with at least some embodiments of the present disclosure;

FIG. 16 is a flowchart of an example process for measuring the productivity of communication sessions and using the measured productivity to improve future communication sessions in accordance with at least some embodiments of the present disclosure; and

FIG. 17 is a flowchart of an example process for measuring the productivity of communication sessions and using the measured productivity to improve future communication sessions in accordance with at least some embodiments of the present disclosure.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides illustrative embodiments only, and is not intended to limit the scope or applicability of the disclosure. Furthermore, to avoid unnecessarily obscuring the present disclosure, the preceding description omits a number of known structures and devices. This omission is not to be construed as a limitation of the scope of the claims. Rather, the ensuing description of the illustrative embodiments will provide those skilled in the art with an enabling description for implementing an illustrative embodiment. It should however be appreciated that the present disclosure may be practiced in a variety of ways beyond the specific details set forth herein.

While the illustrative aspects, embodiments, and/or configurations illustrated herein show the various components of the system collocated, certain components of the system can be located remotely, at distant portions of a distributed network, such as a Local Area Network (LAN) and/or the Internet, or within a dedicated system. Thus, it should be appreciated, that the components of the system can be combined in to one or more devices or collocated on a particular node of a distributed network, such as an analog and/or digital telecommunications network, a packet-switched network, or a circuit-switched network. It will be appreciated from the following description, and for reasons of computational efficiency, that the components of the system can be arranged at any location within a distributed network of components without affecting the operation of the system.

Embodiments of the disclosure provide systems and methods for generating a productivity score for a communication session. In some aspects of the present disclosure, machine learning tools may support generating the productivity score for the communication session. Embodiments of the present disclosure are also contemplated to automatically adjust a duration of the communication session in response to the productivity score exceeding or failing to meet a threshold value or based on rules in combination with the threshold(s) and/or an analysis of previous actions.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configurations, and aspects.

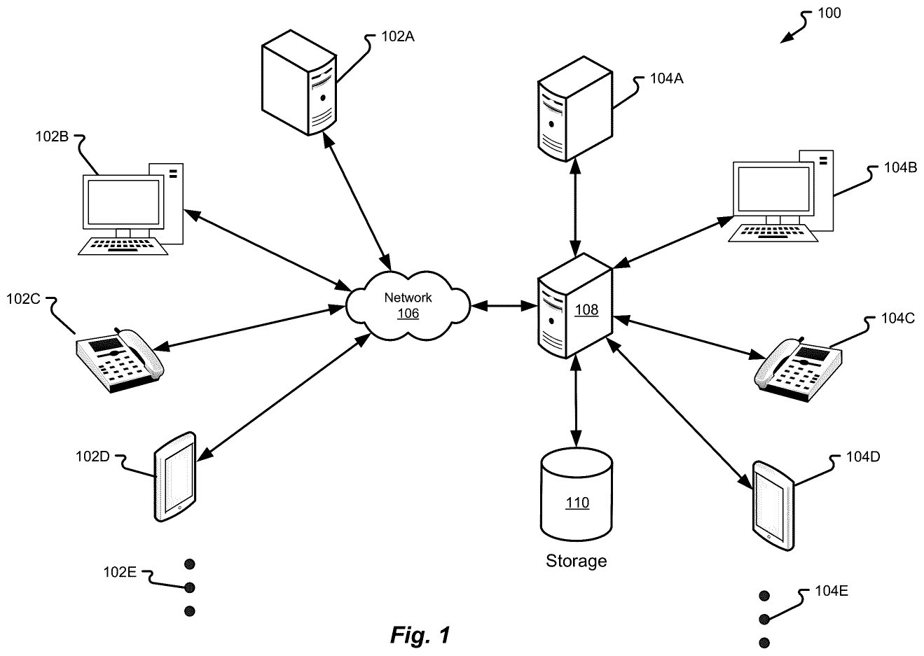

FIG. 1 is a block diagram illustrating a system 100 that supports measuring the productivity of communication sessions and using the measured productivity to improve future communication sessions in accordance with at least some embodiments of the present disclosure. In one embodiment, first user communication device 102 includes one or more devices and/or device types, such as first user communication device 102A being a server, computer, or other communication component; first user communication device 102B includes a computer, laptop, or other application-executing device, such as to execute a softphone, messaging system, video/voice-over-IP, etc. First user communication device 102A and first user communication device 102B may operate independently or cooperatively. First user communication device 102C may be embodied as a telephone (e.g., plain old telephone system (POTS) device, and/or a voice-over-IP (VoIP) device); First user communication device 102D may be a handheld device, such as a personal data assistant, cellular telephone/smart-phone, tablet, etc., which may communicate via cellular communications and/or other wired or wireless networking communications (e.g., WiFi, WiMax, Bluetooth, etc.); and other first user communication device 102E which may include other current or future communication devices for use by a user (not shown in FIG. 1) to communicate with one or more second user communication device 104.

In another embodiment, second user communication device 104 includes one or more devices and/or device types, such as second user communication device 104A which may include a server, computer, or other communication component; second user communication device 104B, which may include a communication terminal with software and/or communications to other components (e.g., processors, storage/memory devices, etc.); second user communication device 104C which may be embodied a telephone (e.g., POTS, VoIP, etc.); second user communication device 104D may be a handheld device, such as a personal data assistant, cellular telephone/smart-phone, tablet, etc., which may communicate via cellular communications and/or other wired or wireless networking communications (e.g., WiFi, WiMax, Bluetooth, etc.); and other second user communication device 104E which may include other current or future communication devices for use by a user (not shown in FIG. 1) to communicate with one or more first user communication device 102.

System 100 omits common components typically utilized to facilitate communication between one or more first user communication device 102 and one or more second user communication device 104. The network 106 can be any type of network familiar to those skilled in the art that can support data communications using any of a variety of commercially-available protocols, including without limitation SIP, TCP/IP, SNA, IPX, AppleTalk, and the like. Merely by way of example, the communication network 104 may correspond to a LAN, such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.9 suite of protocols, the IEEE 802.11 suite of protocols, the Bluetooth® protocol known in the art, and/or any other wireless protocol); and/or any combination of these and/or other networks. Network 106 may be or support communications including one or more types (e.g., video, analog voice, digital voice, text, etc.) and/or media (e.g., telephony, Internet, etc.). Network 106 may include portions of other networks (e.g., ethernet, WiFi, etc.) and/or virtual networks (e.g., VPN, etc.).

Information related to communications may be referred to herein as communication information or communication data and variations of these terms. Communication information can include any type of data related to communications of a user and/or entity (e.g., information being sent to user(s), received from user(s), created by user(s), accessed by user(s), viewed by user(s), etc.). Communication information can include information associated with the communication as well as information contained within the communication (e.g., content of the communication). Thus, communication information may include information not only that is sent and received, but also other information such as information that a user does not necessarily send or receive. Content of communications may be classified in various ways, such as by a timing of the content, items the content is related to, users the content is related to, keywords or other data within fields of the communication (e.g., to field, from field, subject, body, etc.), among other ways of classifying the content. The keywords or other content may be analyzed based on various properties, including their location as it relates to the communication (e.g., a field location within the communication).

Communications between ones of first user communication device 102 and ones of second user communication device 104 may be intercepted or monitored by communication server 108 having a microprocessor with a memory integrated therewith or accessible. Communication server 108 monitors the connection data of the communication and, if a criterion or threshold is met, causes at least a portion of the communication to be stored in data storage 110. For example, spoken words, words/characters in a text or email message, properties regarding the communication, etc., may be intercepted, monitored, scanned, searched, and stored. In another embodiment, data storage 110 may maintain an index, pointer, or other indicia to reference the portion of the communication. The communication server 108 may include, or communicate with, various other servers, memories, modules, and/or engines to implement methods and systems of the present disclosure. The communication server 108 may interact with a set of guidelines (e.g., as a set of static instructions) or by using machine learning. In various embodiments disclosed herein, the communication server 108 may interact with an productivity server, as described herein.

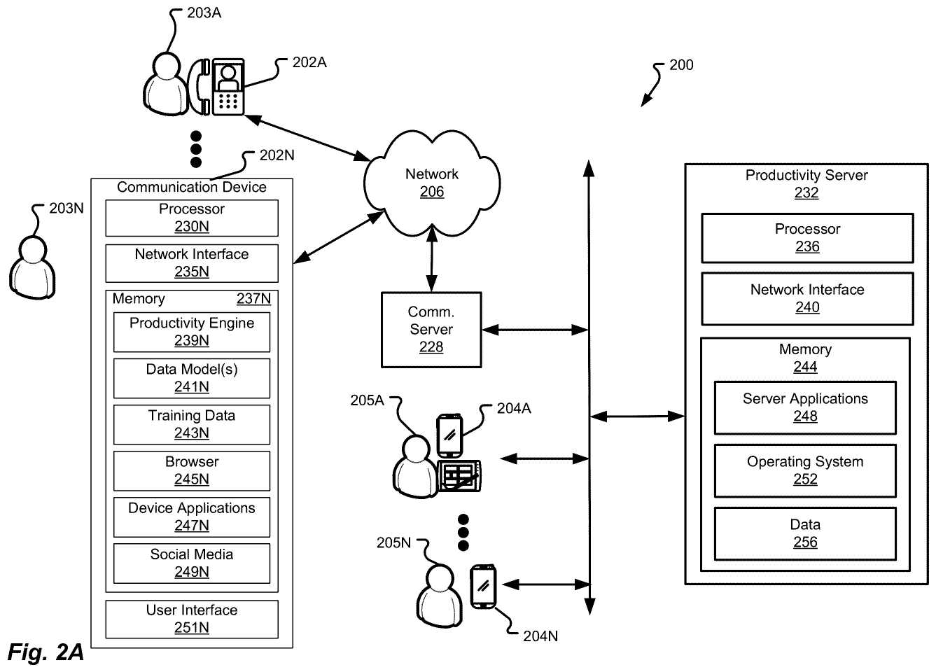

FIG. 2A is a block diagram illustrating a system 200 that supports measuring the productivity of communication sessions and using the measured productivity to improve future communication sessions in accordance with at least some embodiments of the present disclosure. In some aspects of the present disclosure, the components shown in FIG. 2A may correspond to like components shown in FIG. 1. The communication system 200 is shown to include communication network 206 that interconnects users 203A-203N via communication devices 202A-202N with users 205A-205N via communication devices 204A-204N. Users may also be referred to herein as humans, human agents, administrators, participants, and attendees. Network 206 may connect to communication devices in any manner, including via communication server 228. Thus, users 205A-205N may communicate with users 203A-203N through their respective devices and communication server 228 in addition to network 206. Communication server 228 may also communicate with productivity engine 288 (illustrated in FIG. 2B) via a communication channel.

Communication devices as disclosed herein (e.g., 202A-202N and/or 204A-204N) may correspond to a computing device, a personal communication device, a portable communication device, a laptop, a smartphone, a personal computer, and/or any other device capable of running an operating system, a web browser, or the like. For instance, a communication device may be configured to operate various versions of Microsoft Corp.'s Windows® and/or Apple Corp.'s Macintosh® operating systems, any of a variety of commercially available UNIX® such as LINUX or other UNIX-like operating systems, iOS, Android®, etc. These communication devices (e.g., 204A-204N and/or 202A-202N) may also have any of a variety of applications, including for example, a database client and/or server applications, web browser applications, chat applications, social media applications, calling applications, etc., as discussed in greater detail below. A communication device (e.g., 204A-204N and/or 202A-202N) may alternatively or additionally be any other electronic device, such as a thin-client computer, Internet-enabled mobile telephone, and/or personal digital assistant, capable of communicating via communication network 206 and/or displaying and navigating web pages or other types of electronic documents. As illustrated in FIG. 2A, communication device 202N includes a processor 230N, a network interface 235N, a memory 237N including a productivity engine, 239N, data model(s) 241N, training data 243N, browser 245N, device applications 247N, social media 249N and user interface 251N. Although these features are illustrated for communication device 202N, some, most, or all of these features may be included in the other communication devices 202A-202N-1 and 204A-204N.

In addition, embodiments of the present disclosure contemplate that a user (e.g., 203A-203N and/or 205A-205N) may use multiple different communication devices (e.g., multiple of 202A-202N and/or 204A-204N) to communicate via a single asynchronous communication channel. As a non-limiting example, a user may login to a web-based portal or authenticate themselves with a particular chat channel and then utilize the web-based portal or chat channel to communicate with any one of multiple communication devices (e.g., 204A-204N and/or 202A-202N). Alternatively, or additionally, a user may use one of their communication devices (e.g., 204A-204N and/or 202A-202N) to send email messages to another user and use another communication device to send messages of another type (e.g., chat messages or SMS messages) and/or to communicate via a voice channel.

In some embodiments of the present disclosure, one or more servers may be configured to perform particular organizational actions or sets of organizational actions specific to supporting functions of the productivity engine 288. For instance, the communication server 228 may correspond to one or more servers that are configured to receive communications and make routing decisions for the communications, as well as maintain other communication data such as calendar data. The communication server 228 may correspond to a single server or a set of servers that are configured to establish and maintain communication channels between users 203A-203N and 205A-205N and may contain processor(s) and memory to store and manage communications data. In some embodiments of the present disclosure, the communication server 228 may work in cooperation with the productivity engine 288 to manage and process information, as described herein.

In some embodiments, the communication server 228 may be responsible for establishing and maintaining communications including digital text-based communication channels as well as voice channels between users 203A-203N and 205A-205N. The communication server 228 can establish and maintain communication data. As discussed herein, communication data includes and is not limited to any data involving communications of a user and includes calendar and other event information. Thus, as some non-limiting examples, the communication server 228 may be configured to process calendar information and communications received from a user communication device (e.g., 204A-204N and/or 202A-202N) and utilize a calendar protocol and an email messaging protocol. Non-limiting examples of protocols that may be supported by the communication server 228 include Internet Message Access Protocol (IMAP), Post Office Protocol (POP), Simple Mail Transfer Protocol (SMTP), and Exchange. The communication server 228 may alternatively or additionally be configured to support real-time or near-real-time text-based communication protocols, video-based communication protocols, and/or voice-based communication protocols. Various functionality of the communication server 228 may be performed by the productivity engine 288, the productivity server 232, and/or other servers and server components such as additional memory and processors (not shown).

It should be appreciated that the communication server 228 may be configured to support any number of communication protocols or applications whether synchronous or asynchronous. Non-limiting examples of communication protocols or applications that may be supported by the communication server 228 include the Session Initiation Protocol (SIP), File Transfer Protocol (FTP), Hypertext Transfer Protocol (HTTP), HTTP secure (HTTPS), Transmission Control Protocol (TCP), Java, Hypertext Markup Language (HTML), Short Message Service (SMS), Internet Relay Chat (IRC), Web Application Messaging (WAMP), SOAP, MIME, Real-Time Messaging Protocol (RTP), Web Real-Time Communications (WebRTC), WebGL, XMPP, Skype protocol, AIM, Microsoft Notification Protocol, email, etc. Again, in addition to supporting text-based communications, the communication server 228 may also be configured to support non-text-based communications such as voice communications, video communications, and the like.

The communication server 228 may also be configured to manage any other type of communication information such as events and action items. The information can be related to entities or users 203A-203N and 205A-205N. For example, the events may be information related to calendar information, meeting information (including meeting topics, dates/times, attendee information, meeting minutes, meeting summaries, voice-to-text transcripts, etc.) and action items. Action items may include activities or tasks to be performed by a user, a group of users, and/or an automated component in connection with a communication and/or an event. Organizational actions include events and action items. The communication server 228 may be configured to maintain state information for one or more users 203A-203N and 205A-205N at any given point in time. The communication server 228 may also be configured to manage and analyze historical information. Historical information may be used as part of training and updating automated engines (e.g., a text analysis engine 260, a topic analysis engine 264, a recording analysis engine 268, a scoring module 278, an analysis module 280, a recommendation module 282, a user interface module 284 and/or a productivity engine 288) each of which is illustrated in FIG. 2B. In some embodiments of the present disclosure, the communication server 228 may further interact with the text analysis engine 260, the topic analysis engine 264, the recording analysis engine 268, the scoring module 278, the analysis module 280, the recommendation module 282, the user interface module 284 and/or the productivity engine 288 to configure the methods and systems disclosed herein. These capabilities of the communication server 228 may be provided by one or more modules stored in memory and executed by one or more processors of the communication server 228.

In addition, the communication server 228 may be responsible for obtaining user 203A-203N and/or 205A-205N information from various sources (e.g., contact information, meeting information, event information, social media, presence statuses, state information, etc.) to support the methods and systems disclosed herein. In some embodiments of the present disclosure, the communication server 228 may be configured to maintain a user database that may be internal to, or external from, the communication server 228. The user database (not shown in FIG. 2A) may be used to store user information in any number of data formats. The communication server 228 may be configured to obtain and provide relevant user information to any of the text analysis engine 260, the topic analysis engine 264, the recording analysis engine 268, the scoring module 278, the analysis module 280, the recommendation module 282, the user interface module 284 and/or the productivity engine 288, thereby facilitating the productivity server's 232 ability to implement the methods and systems disclosed herein.

The productivity server 232 is shown to include a processor 236 and a network interface 240 in addition to memory 244. The processor 236 may correspond to one or many computer processing devices. Non-limiting examples of a processor include a microprocessor, an Integrated Circuit (IC) chip, a General Processing Unit (GPU), a Central Processing Unit (CPU), or the like. Examples of the processor 236 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The network interface 240 may be configured to enable the productivity server 232 to communicate with other machines in the system 200 and/or to communicate with other machines connected with the communication network 206. The network interface 240 may include, without limitation, a modem, a network card (wireless or wired), an infra-red communication device, etc.

For example, memory 244 includes instructions to enable processor 236 to execute one or more applications, such as server applications 248, operating system 252, and any other type of application or software known to be available on computer systems. Memory 244 also includes data 256. Alternatively, or additionally, the instructions, application programs, or the like can be stored in an external database (which can also be internal to productivity server 232—not shown) or external storage or database 276 in communicatively coupled with productivity server 232 (illustrated in FIG. 2B), such as one or more database or memory accessible over network 206. Memory 244 may include one or multiple computer memory devices. The memory 244 may be configured to store program instructions that are executable by the processor 236 and that ultimately provide functionality of the productivity server 232 described herein. Memory 244 may also be configured to store data or information that is useable or capable of being called by the instructions stored in memory 244. One example of data that may be stored in memory 244 for use by components thereof is one or more data model(s) 272 and/or training data 274 (illustrated in FIG. 2B). The memory 244 may include, for example, Random Access Memory (RAM) devices, Read Only Memory (ROM) devices, flash memory devices, magnetic disk storage media, optical storage media, solid-state storage devices, core memory, buffer memory devices, combinations thereof, and the like. The memory 244, in some embodiments of the present disclosure, corresponds to a computer-readable storage media and while the memory 244 is depicted as being internal to the productivity server 232, it should be appreciated that the memory 244 may correspond to a memory device, database, or appliance that is external to the productivity server 232.

Server application(s) 248, such as a conferencing application, causes processor 236 to perform one or more functions of the disclosed methods. For example, server application(s) 248 in conjunction with the user interface module 284 discussed below, cause processor 236 to provide a graphical user interface representative of a conference call in an online environment to a plurality of participants in the communication session (e.g., to communication devices 202A-202N and 204A-204N), wherein the graphical user interface includes representations of the plurality of participants (e.g., participants 203A-203N and 205A-205N), and the representations are based on productivity scores associated with the plurality of participants; acquire data from one or more of the plurality of participants representative of a participation level of a participant of the plurality of participants; update the productivity score associated with the participant using the acquired data; determine changes to the graphical user interface based on a comparison of the scores associated with the plurality of participants; and provide the changes to the graphical user interface to the plurality of participants.

According to further embodiments of the present disclosure, server application(s) 248 in conjunction with the user interface module 284 discussed below, cause processor 236 to provide a graphical user interface including a productivity score determined utilizing artificial intelligence (AI) and/or machine learning to gather data (including user feedback) to include some or all components of the data of the meeting parameters and/or meeting conditions to provide an analysis of what works and what needs improvement during a communication session. Besides the productivity score, comments, recommendations, suggestions, and additional information may be provided in the graphical user interface.

In some embodiments of the present disclosure, program(s) include operating system 252 performing operating system functions when executed by one or more processors such as processor 236. By way of example, operating system 252 include Microsoft Windows™ Unix™, Linux™, Apple™ operating systems, Personal Digital Assistant (PDA) type operating systems, such as Microsoft CE™, or other types of operating systems. Accordingly, disclosed embodiments of the present disclosure can operate and function with computer systems running any type of operating system 252. Productivity server 232 can also include communication software that, when executed by a processor, provides communications with network 206 and/or a direct connection to one or more of the communication devices 202A-202N and 204A-204N via network interface 240.

In some embodiments of the present disclosure, data 256 includes, for example, multimedia conference contents, substitute contents, and/or other elements used to construct the graphical user interface for the conference call. For example, data 256 includes buffered or processed video/audio streams provided by communication devices 202A-202N and 204A-204N, information associated with the present or previous conference call, a video clip introducing a participant 203A-203N and 205A-205N, a video clip providing conference call related information, photos of the multimedia conference call participants, one or more audio messages, avatars associated with conference call participants, and/or widgets used to provide feedback. Data 256 can further include participant feedback and conference call evaluations including explicit and implicit participant evaluations and raw sensor data (e.g., data from a proximity sensor, a light sensor, a motion sensor, a biometric sensor, and/or other sensor(s)).

FIG. 2B is a block diagram illustrating the productivity server 232 that supports measuring the productivity of communication sessions and using the measured productivity to improve future communication sessions in accordance with at least some embodiments of the present disclosure. As shown in FIG. 2B, the productivity server 232 further includes structures such as modules, engines and/or components that can be packaged hardware units designed for use with other components, executable instructions, or a part of a program that performs a particular function. Each module or engine can consist of multiple sub-modules or can be a sub-module that is part of a corresponding module. As shown in this example, the productivity server 232 includes the text analysis engine 260, the topic analysis engine 264, the recording analysis engine 268, the scoring module 278, the analysis module 280, the recommendation module 282, the user interface module 284, the productivity engine 288, data model(s) 272 and the training data 274. The components shown in FIG. 2B can be stored in memory 244 and executed on processor 236. These modules can also be stored as server application(s) 248 that provide the disclosed functionality. Similar to FIG. 2A, the modules and components in FIG. 2B can access network interface 240 and database 276.

In some embodiments of the present disclosure, each of the text analysis engine 248, the topic analysis engine 252, the recording analysis engine 264, the scoring module 278, the analysis module 280, the recommendation module 282, the user interface module 284 and/or the productivity engine 288 may correspond to a set of processor-executable instructions (e.g., a finite instruction set with defined inputs, variables, and outputs). In some embodiments of the present disclosure, the text analysis engine 260, the topic analysis engine 264, the recording analysis engine 268, the scoring module 278, the analysis module 280, the recommendation module 282, the user interface module 284 and/or the productivity engine 288 may correspond to an AI component of the productivity server 232 that is executed by the processor 236. Each of the text analysis engine 260, the topic analysis engine 264, the recording analysis engine 268, the scoring module 278, the analysis module 280, the recommendation module 282, the user interface module 284 and/or the productivity engine 288 in some embodiments of the present disclosure, may utilize one or more data model(s) 272, which may be in the form of an artificial neural network, for recognizing and processing the information obtained from communication devices 202A-202N and/or 204A-204N and/or supported by the communication server 228. In some embodiments of the present disclosure, the text analysis engine 260, the topic analysis engine 264, the recording analysis engine 268, the scoring module 278, the analysis module 280, the recommendation module 282, the user interface module 284 and/or the productivity engine 288 may each be trained with training data 274 and may be programmed (i.e., learns from user feedback and tunes to user preferences) to learn from additional communication information, including meetings as such meetings are scheduled and/or occur, events as such events are scheduled and/or occur, actions items as such action items are scheduled and/or occur, conversations as such conversations occur, or after any of these items occur. In some embodiments of the present disclosure, any one or more of the text analysis engine 260, the topic analysis engine 264, the recording analysis engine 268, the scoring module 278, the analysis module 280, the recommendation module 282, the user interface module 284 and the productivity engine 288 may update one or more of the data model(s) 272 as they learn from ongoing information.

Database 276 or other external storage is a volatile or non-volatile, magnetic, semiconductor, tape, optical, removable, non-removable, or other type of storage device or tangible or non-transitory computer-readable medium. Memory 244 and database 276 can include one or more memory devices that store data and instructions used to perform one or more features of the disclosed embodiments. Memory 244 and database 270 can also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments of the present disclosure, the productivity server 232 is communicatively coupled to one or more remote memory devices (e.g., remote databases (not shown)) through network 206 or a different network. The remote memory devices can be configured to store information that productivity server 232 can access and/or manage. By way of example only, the remote memory devices could be document management systems, Microsoft SQL database, SharePoint databases, Oracle™ databases, Sybase™ databases, or other relational databases. Systems and methods consistent with disclosed embodiments, however, are not limited to separate databases or even to the use of a database.

As can be appreciated by one skilled in the art, functions offered by the elements depicted herein may be implemented in one or more network devices (i.e., servers, networked user device, non-networked user device, etc.).

The productivity server 232 and/or the productivity engine 288 may be configured to coordinate tasks between the text analysis engine 260, the topic analysis engine 264, the recording analysis engine 268, the scoring module 278, the analysis module 280, the recommendation module 282 and/or the user interface module 284. The productivity server 232, the text analysis engine 260, the topic analysis engine 260, the recording analysis engine 268, the scoring module 278, the analysis module 280, the recommendation module 282, the user interface module 284 and/or the productivity engine 288 may have any configuration and may be made up of more or less components than what is shown in FIG. 2B. For example, the productivity server 232 or the productivity engine 288 may perform all of the tasks of the text analysis engine 260, the topic analysis engine 264, the recording analysis engine 268, the scoring module 278, the analysis module 280, the recommendation module 282 and the user interface module 284 as described herein, or each of the text analysis engine 260, the topic analysis engine 264, the recording analysis engine 268, the scoring module 278, the analysis module 280, the recommendation module 282 and/or the user interface module 284 can perform tasks independently, without interacting with the productivity server 232 or the productivity engine 288. In various embodiments of the present disclosure, settings of the productivity server 232, or any of its components, may be configured and changed by any users 203A-203N and 205A-205N and/or administrators of the system. Settings can include alerts and thresholds as well as settings related to how information is collected, organized, and displayed. Settings may be configured to be personalized for one or more communication devices (e.g., 204A-204N and/or 202A-202N) and/or users (e.g., 203A-203N and 205A-205N), and may be referred to as profile settings.

The productivity server 232 may calculate or generate a productivity score for a communication session based on thresholds set by automatic processing, by machine learning and/or one or more users 203A-203N and 205A-205N. The thresholds may be set individually to determine an acceptable productivity score for one or more of the meeting parameters such as the time meeting parameters, the location meeting parameters, the participant meeting parameters and the topic meeting parameters. Thresholds may also be set individually to determine an acceptable productivity score for one or more meeting conditions.

With respect to the topic meeting parameters, actions may be associated with any desired information, such as a particular set of keywords, one or more topics, etc., and configured with any desired criteria. Actions may be personalized to one or more communication devices (e.g., 204A-204N and/or 202A-202N) and/or users (e.g., 203A-203N and 205A-205N) and may have any properties desired by a user (e.g., a desired run time, various specified groups of attendees and/or users 203A-203N and 205A-205N, preferred locations, preferred timings, etc.). Actions can include configuring notification settings (e.g., for a user to be notified if a productivity score is above or below the threshold value or a recommendation to improve the productivity in the present call or a future call) and recording settings (e.g., to record events such as meetings, communications, etc.). The actions can be configured to be implemented automatically (e.g., automatically recording and analyzing meeting discussions).

In some aspects of the present disclosure, different thresholds may be used to configure various notifications and/or recordings. For example, the thresholds may correspond to one or more specified sub-topics classified as being within a topic, a detection of a specified number of repetitive words occurring within certain content, locations of keyword(s) within information, a detection of a specified number of repetitive words occurring over a specified timeframe, etc. Settings related to actions and thresholds, including data regarding events, notifications, and recordings, may be stored at any location. The settings may be predetermined (e.g., automatically applied by the productivity server 232 and/or set or changed based on various criteria). The settings are configurable for any time or in real-time. For example, monitoring, searching, etc., may occur at any time or continuously in real-time.

Settings related to actions and thresholds can include customized settings for any user, device, or groups of users or devices. For example, users 203A-203N and 205A-205N may each have profile settings that configure one or more of their thresholds, preferred settings regarding recordings, etc., among other user preferences. Settings chosen by an administrator, or a certain user may override other settings that have been set by other users 203A-203N and 205A-205N, or settings that are set by default. Alternatively, settings chosen by a user may be altered or ignored based on any criteria at any point in the process. For example, settings may be created or altered based on a user's association with a position, a membership, or a group, based on a location or time of day, or based on a user's identity or group membership, among others.

Additional capabilities of the productivity server 232 will be described in further detail with respect to operations of the text analysis engine 260, the topic analysis engine 260, the recording analysis engine 268, the scoring module 278, the analysis module 280, the recommendation module 282, the user interface module 284 and the productivity engine 288, which are shown to be provided by the productivity server 232. While certain components are depicted as being included in the productivity server 232, it should be appreciated that such components may be provided in any other server or set of servers. For instance, components of the productivity server 232 may be provided in a separate engine (not shown) and/or in the communication server 228, in an engine of the communication server 228, etc., and vice versa. Further still, embodiments of the present disclosure contemplate a single server that is provided with all capabilities of the communication server 228 and the productivity server 232.

The text analysis engine 260 may be configured to analyze textual information, including voice-to-text information that is generated before, during or after a communication session. As described herein, textual information may include and is not limited to calendar information (including scheduling information associated with a particular meeting(s) and/or locations, user calendar and scheduling information, etc.), user preferences, user physical location information, user and/or location contact data, etc.), message information (including textual message information, message responses, message processing history, message keywords, message notes, user notes associated with one or more messages, message configurations, message origination(s) and destination(s)), and meeting information (including meeting minutes, meeting notes, to do items, action items, meeting scheduling information, etc.). Voice-to-text information may be any audio information that is converted to text and may include communications with an audio component (e.g., voice calls, voice messages, video calls, meeting recordings, etc.) as it relates to what is to be discussed during the communication session. A previously created agenda is used to determine the relevance from the text analysis engine 260. The textual information may be historical information, or information that is being recorded in real-time. The text analysis engine 260 may provide appropriate signaling to a communication device (e.g., 204A-204N and/or 202A-202N) and/or the communication server 228 that enables the text analysis engine 260 to receive textual information from the communication device(s) and/or the communication server 228. As discussed below, the scoring module 278, the analysis module 280 and the recommendation module 282 uses the results from the text analysis module 260 along with the meeting parameters and the meeting conditions to generate productively score for a communication session.

The topic analysis engine 264 may be configured to analyze topics contained within various types of information, including audio and textual information that is generated before, during or after a communication session. The topics may be identified by the topic analysis engine 264 from the information, may be identified within the information itself, and may be identified by external sources, such as from information received from the communication server 228, other information received over the network 206, and/or information received from one or more users 203A-203N and 205A-205N. Topics may be determined prior to the communication session, by automatic processing, by machine learning and/or one or more users 203A-203N and 205A-205N. The topics may be historical information, or they may be identified by analyzing information in real-time. The topic analysis engine 264 may provide appropriate signaling to a communication device (e.g., 204A-204N and/or 202A-202N) and/or the communication server 228 that enables the topic analysis engine 264 to receive information from the communication device(s) and/or the communication server 228. As discussed below, the scoring module 278, the analysis module 280 and the recommendation module 282 uses the results from the topic analysis module 264 along with the meeting parameters and the meeting conditions to generate a productively score for a communication session.

The recording analysis engine 268 may be configured to analyze recorded information, including voice-to-text information. The recorded information may be historical information, or information that is being recorded in real-time. As described herein, recorded information may include and is not limited to meeting recordings, voicemail recordings, recordings of a video call, and voice call recordings. The recording analysis engine 268 may provide appropriate signaling to a communication device (e.g., 204A-204N and/or 202A-202N) and/or the communication server 228 that enables the recording analysis engine 268 to receive audio information from the communication device(s) and/or the communication server 228. As discussed below, the scoring module 278, the analysis module 280 and the recommendation module 282 uses the results from the recording analysis module 260 along with the meeting parameters and the meeting conditions to generate a productivity score for a communication session.

The analysis module 280 utilizes AI or machine learning to gather data from the text analysis engine 260, the topic analysis engine 264, the recording analysis engine 268, the meeting parameters and/or the meeting conditions. A quantitative analysis is performed on the gathered data and then sent to the scoring module 278. The scoring module 278 provides a productivity score for the analyzed gathered data. The productivity score can be based on settings and compared to thresholds, rankings, trends, etc. as discussed above. For example, a preliminary productivity score can be generated and later modified or adjusted based on the time (e.g., in the morning verses in the afternoon) or the location (e.g., remote verses local) of the communication session, the participants to the communication session, the topics discussed or not discussed during the communication session, the type of communication session (a general call verses an agenda-focused call), etc.

After, or along with generating the productivity score, recommendation module 282 may provide comments, recommendations, suggestions, and/or additional information regarding the qualitative analysis and/or the productivity score for the communication sessions. Nonlimiting examples of the comments, recommendations, suggestions, and/or additional information for the qualitative analysis include: (1) how the meeting ended: were there indications that it was good conversation, a good discussion, a healthy discussion, more such meetings should take place, etc. provided by the participants to the communication session or other team members; (2) the overall sentiment of the meeting: too many back and forth arguments or the participants are in agreement with each other, etc.; (3) suggested follow up—the agenda was not completed and/or (4) the scope of the discussion changed during the meeting, to name a few. Moreover, nonlimiting examples of the comments, recommendations, suggestions, and/or additional information for the productivity score may include a determination which day of the week productivity is better (e.g., the start of the week versus the middle of the week versus the end of the week) to improve the productivity score.

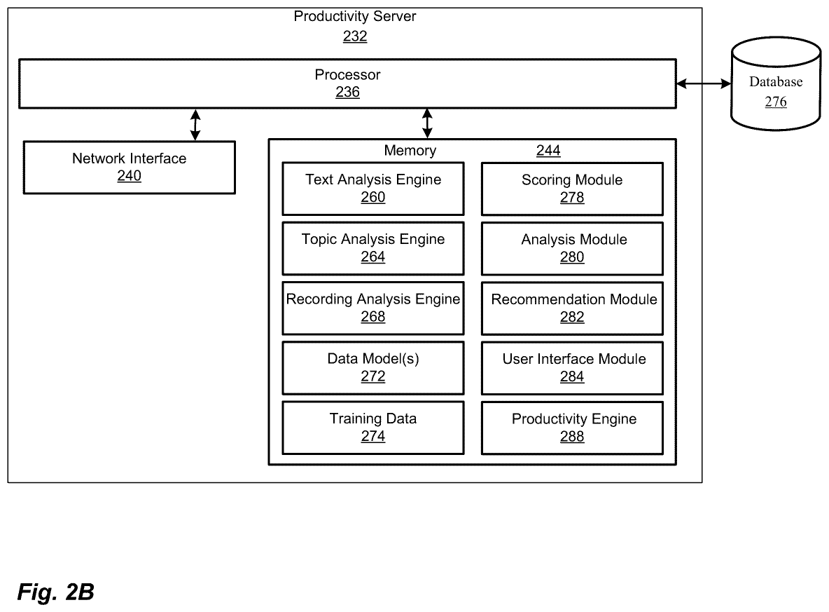

Further details of the productivity engine 288 regarding the topic meeting parameters utilizing machine learning are described with reference to FIG. 3. FIG. 3 is a block diagram illustrating a productivity engine 388 of a productivity server that supports measuring the productivity of communication sessions and using the measured productivity to improve future communication sessions in accordance with at least some embodiments of the present disclosure. In some aspects of the present disclosure, the components shown in FIG. 3 may correspond to like components shown in FIGS. 1, 2A and 2B. FIG. 3 shows a system 300 including the productivity engine 388 together with a communication server 328, recording analysis engine 364, and associated components.

In various embodiments, the productivity engine 388 may correspond to the productivity server 232 of FIG. 2B. The productivity engine 388 is particularly described with respect to the topic meeting parameters, but other meeting parameters as well as meeting conditions can also be used. According to embodiments of the present disclosure, the productivity engine 388 can create and select appropriate processing decisions. Processing decisions may include one or more of scanning, matching, comparing (e.g., to other communication information or to other set values or variables such as one or more thresholds), displaying, editing, saving, and deleting. The productivity engine 388 may manage productivity scores. Processing decisions and actions may be handled automatically by the productivity engine 388 without human input.

The productivity engine 388 may generate productivity scores for topic meeting parameters based on input from historical databases (e.g., historical text database 316, historical topic database 317, and/or historical recordings database 367) and based on communication information inputs received from the communication server 328. As explained herein, in some embodiments, various components of system 300 may be combined or not present in system 300; for example, there may be only one training/learning module that operates in combination with a single database containing training data and data models and only one engine that handles all of the components and functionality for text, topics, and recordings.

Components of system 300 may have access to training data 360 and 361. For example, the text analysis training data and feedback 360 may initially train behaviors of the text analysis engine 348 to utilize machine learning, and the topic analysis training data and feedback 361 may initially train behaviors of the topic analysis engine 352 to utilize machine learning. The text analysis engine 348 and the topic analysis engine 352 may each also be configured to learn from further information based on feedback, which may be provided in an automated fashion (e.g., via a recursive learning neural network) and/or a human-provided fashion (e.g., by one or more human users 205A-205N and/or 203A-203N).

The learning/training modules 309 and 311 of the productivity engine 388 may have access to and use one or more data models 356 and 357. For example, the text analysis data model 356 may be built and updated by the text analysis training/learning module 309 based on the text analysis training data and feedback 360. Similarly, the topic analysis data model 357 may be built and updated by the topic analysis training/learning module 311 based on the topic analysis training data and feedback 361. The data models 356 and 357 may be similar to or different from one another and may be provided in any number of formats or forms. Non-limiting examples of data models 356 and 357 include Decision Trees, SVMs, Nearest Neighbor, and/or Bayesian classifiers.

The learning/training modules 309 and 311 may also be configured to access information from respective decision databases 312 and 313 for purposes of building each of the respective historical databases 316 and 317, which effectively store historical information. Data within the historical databases 316 and 317 may constantly be updated, revised, edited, or deleted by the respective learning/training modules 309 and 311 as the productivity engine 338 processes more information received from communication server 328.

Information stored in historical text database 316 may include and is not limited to communication information (including message information that may be textual message information, message responses, message processing history, message keywords, message notes, user notes associated with a message, topic information, message configurations, and message origination(s) and destination(s)), user preferences regarding textual information, location information (which may be location(s) of text within information, location(s) associated with text, etc.), and meeting information. Meeting information can include meeting minutes, meeting notes, to do items, action items, meeting scheduling information, other calendar information (including scheduling information associated with a particular meeting(s) and/or location(s), user calendar and scheduling information, etc. Textual information obtained by voice-to-text may also be stored in historical text database 316. The textual information may include textual information that was recorded or was processed by voice-to-text processing, in real-time. Further, information regarding the importance of different text as well as how to determine importance (e.g., location of keywords/key phrases, repetition of keywords/key phrases, explicit definitions of importance of text, classifications of text, rankings of text, and user preferences regarding text, etc. may be stored in historical text database 316.

Information stored in historical topic database 317 may include and is not limited to topics related to meetings, events, communications, to do items, and actions items, as well as information related to topics, such as keywords, key phrases, information regarding the importance of different types of topics as well as how to determine importance (e.g., location of keywords/key phrases, repetition of keywords/key phrases, explicit definitions of topics and importance of topics, classifications of topics, rankings of topics, and user preferences regarding topics, etc.). Topic information obtained by voice-to-text also be stored in historical topic database 317. The topic information may include topic information that was recorded, topic information that was processed (e.g., by voice-to-text processing), in real-time, and proposed topic information.

In some embodiments, the productivity engine 388 may include multiple engines, such as the text analysis engine 348 and the topic analysis engine 352. In system 300, the text analysis engine 348 has access to the historical text database 316, the text decision database 312, the text analysis event inputs 324, and the text analysis event decisions 320. The topic analysis engine 352 has access to the historical topic database 317, the topic decision database 313, the topic analysis event inputs 325, and the topic analysis event decisions 321.

The text analysis engine 348 may provide appropriate signaling to the communication server 328 that enables the text analysis engine 348 to receive textual information from the communication server 328. Further, if data from the communication devices (e.g., 204A-204N and/or 202A-202N) is not provided via the communication server 328, the text analysis engine 348 may provide appropriate signaling to one or more of the communication devices (e.g., 204A-204N and/or 202A-202N) that enables the text analysis engine 348 to receive textual information from the communication device(s) (e.g., 204A-204N and/or 202A-202N).

The topic analysis engine 352 may provide appropriate signaling to the communication server 328 that enables the topic analysis engine 352 to receive topic information from the communication server 328. Further, if data from the communication devices (e.g., 204A-204N and/or 202A-202N) is not provided via the communication server 328, the topic analysis engine 352 may provide appropriate signaling to one or more of the communication devices (e.g., 204A-204N and/or 202A-202N) that enables the topic analysis engine 352 to receive textual information from the communication device(s) (e.g., 204A-204N and/or 202A-202N).

Each of the text analysis engine 348 and the topic analysis engine 352 can create and select appropriate processing decisions (e.g., recommending, configuring, displaying, updating, revising, editing, deleting, and/or implementing actions) based on input from their respective historical database 316 and 317 and based on communication inputs received from the communication server 328. The communication inputs from the communication server 328 may be provided to the text analysis engine 348 from the text analysis event inputs 324 and may be provided to the topic analysis engine 352 from the topic analysis event inputs 325, before, during or after a communication session.

The text analysis event inputs 324 may include information about textual information handled by the communication server 328 before, during or after a communication session. For example, textual information may include text related to entity information, user and non-user information, contact information, etc. Textual information can be related to communications or events, including meeting information. Thus, for example, the communication server 328 may receive information from email and voice-to-text phone calls that includes details regarding a meeting agenda, dates and time of the meeting, and meeting attendee information. The communication server 328 may also receive textual information from the recording analysis engine 364. The communication server 328 may provide all of this textual information to the text analysis event inputs 324. Alternatively, the communication server 328 may provide none or only some of the textual information to the text analysis event inputs 324 based on processing rules. The rules may be established by automatic processing, by machine learning, or they may be defined by a user or entity.

The topic analysis event inputs 325 may include information about topic information handled by the communication server 328. For example, the topic information may include topics related to entity information, user and non-user information, contact information, etc. The topic information can be related to communications or events, including meeting information. Thus, for example, the communication server 328 may receive information from email and voice-to-text meeting minutes that includes details regarding a meeting topic and meeting action item information. The communication server 328 may also receive topic information from the recording analysis engine 364. The communication server 328 may provide communication information to the topic analysis event inputs 325. As described herein, the communication information can be analyzed by identifying keywords associated with defined topics, repeated words, repetitions of keywords, etc. The rules for identifying topic information to input to the topic analysis event inputs 325 may be established automatically (for example based on thresholds), by machine learning, or they may be defined by a user or entity. The meeting action items that have topics associated therewith may be provided as input to the topic analysis event inputs 325 by the communication server 328. Alternatively, the communication server 328 may provide none or only some of the topic information to the topic analysis event inputs 325 based on one or more rules.

The communication server 328 may provide any information to the text analysis event inputs 324 and the topic analysis event inputs 325, including information not necessarily related to textual information and topic information. In various embodiments of the presented disclosure, the text analysis engine 348 and the topic analysis engine 352 may be responsible for processing voice and/or text during a communication session. Thus, portions or all of the same information may be provided to the text analysis event inputs 324 and the topic analysis event inputs 325.

Using the text analysis event inputs 324 and the historical text database 316, the text analysis engine 348 along with the analysis module 280 and the scoring module 278 may be configured to generate productivity scores. The text analysis engine 348 along with the analysis module 280 and the scoring module 278 may use rules and thresholds to assist in generating productivity scores with respect to topics. The text analysis event decision 320 may be provided as an output of the productivity engine 388 back to the communication server 328.

In various embodiments, the recording analysis engine 364 may be a part of the productivity engine 388. Further, the recording analysis engine 364 may be configured to use machine learning, similar to the text analysis engine 348 and the topic analysis engine 352. The recording analysis engine 364 may share components (e.g., training data and feedback, data model(s), etc.) with one or more of the text analysis engine 348 and the topic analysis engine 352. Alternatively, one or more of the text analysis engine 348 and the topic analysis engine 352 may have a configuration similar to the recording analysis engine 364.

To enhance capabilities of the productivity engine 388, the productivity engine 388 may constantly be provided with updated training data 360 and 361. The training data may be communication inputs in the form of communication information, including real-time communication data from users 203A-203N and 205A-205N. It is possible to train the productivity engine 388 to have a particular output or multiple outputs.

Referring back to FIG. 2B, the scoring module 278 maintains scores for communication sessions and can retrieve and update the scores. Moreover, the scoring module 278 can also maintain scores for each of the participants to the communication session and can retrieve and update the scores associated with the participants in a conference call. Scoring module 278 can base score updates on a variety of factors. For example, feedback from analysis module 280, recommendation module 282, user interface server 284, and other connected components, direct participant feedback, and internal calculations can drive modifications to the communication session's score and well as the participant's score. Moreover, scoring module 278 can receive and process information affecting a participant's score at any time and is not limited to receiving data associated with the current conference call, current conference call participants, or an active conference call.

Scoring module 278 can also store scores in database 276. Scores in database 276 are not limited to only scores for the communication sessions, but scores for participants as well. Moreover, the scores in database 276 are provided for participants in a current communication session. Database 276 can store scores for any individual or entity that can participate in a communication session. Scoring module 278 can receive information from, among other sources, analysis module 280, recommendation module 282, and user interface server 284, update the score for the participant and store the updated score in database 276. The score associated with a participant can represent the level of participation of the participant in the conference call. Scoring module 278 can update the scores for participants in the conference call as the conference call takes place in real time or through additional analysis performed after the completion of the conference call. Each score can be increased and decreased as scoring module 278 acquires new data. Scores associated with the communication session can represent the type of call (e.g., a general call verses an agenda-focused call), the time the call was made, the location of the call, etc.

Scoring module 278 can consider contextual information when accessing and manipulating scoring information. For example, participants who have expertise can have higher scores if the subject matter of the communication session matches their particular expertise. Conversely a participant who lacks expertise matching the specific context of a communication session can have a lower initial score in that particular communication session. A participant's expertise may be determined from an internal database or an enterprise global contact list, or from external sources, namely professional directories such as LinkedIn®. In these examples, the initial score for the same participant can thus be different depending on the context of the communication session.

In some embodiments of the present disclosure, the position of the participant within an organization or entity can drive the participant's score. For example, in these embodiments of the present disclosure, a vice president starts with an initially higher score than an entry-level employee, or vice versa. Moreover, the contextual information associated with a participant can also affect the significance of score updates. For example, the vice president can be less susceptible to negative score adjustments than employees lower in the organizational chart, or vice-versa. Scoring module 278 can store contextual information associated with a participant that can affect initial scoring and score updates in database 276 and provide that contextual information to other modules (e.g., analysis module 280 and recommendation module 282).

Additionally, scoring module 278 can retrieve contextual information from data sources external to productivity server 232. For example, organizations or entities can maintain separate systems for managing projects, team collaboration, email, internal discussions and communication, and internal documentation and resources. Additionally, an organization can maintain an employee directory that includes an employee's biographical data, technical, practical, and job experience, position in the structure and hierarchy of the organization (e.g., based on an organizational chart), and relationships with other employees. By integrating such a directory with productivity server 232 using a directory service, productivity server 232 can use this additional contextual information in scoring, for example, the scoring behavior for a vice president of the organization is different than that for an entry-level employee.

These systems can contain information about the activity level of various participants who can join a conference call as well as non-conference call interactions between conference call participants. For example, in a collaboration session between various participants, some participants may make more significant contributions to the collaboration session by, for instance, posting a higher volume of relevant messages or completing a larger number of tasks associated with the collaboration session. Similarly, in an email thread pertaining to a project, some participants may make a larger contribution to the discussion by sending a higher number of correspondences. These types of systems can be generically referred to as project data systems and can include any systems, infrastructures, or storage of data related to the participants and/or their interactions with each other. In some embodiments of the present disclosure, scoring module 278 has direct access to project data systems. In other embodiments, scoring module 278 accesses project data systems through another module, component, or layer that provides access to the data stored in a project data system.

In some embodiments of the present disclosure, scoring module 278 uses this information combined with contextual information regarding an active conference to establish initial and ongoing scores for the conference call participants. For example, a project data system can contain information about materials and discussions for a particular project created by a particular participant. In this example, scoring module 278 can adjust the score for the particular participant in conference calls about the particular project based on the data acquired from the collaboration system. For example, if a participant has extensive experience with project packaging, the participant is a backend software engineer, and the conference call is related to in store product marketing, one participant may start with a much higher score than another participant when the conference call begins. In these embodiments, activity outside of productivity server 232 can affect a calculated score for a conference call participant.

Scoring module 278 can also access data available from other participants in the conference call through communication server 228. Communication server 228 can provide input data retrieved from participant devices (e.g., communication devices 202A-202N and 204A-204N) connected to the communication server 228. In some embodiments of the present disclosure, the input data includes direct feedback from participants that explicitly identify positive or negative contributions of other conference call participants. Participants can provide this feedback through widgets or other interactive elements included in the graphical user interface displayed on the multimedia electronic devices (e.g., communication devices 202A-202N and 204A-204N). In these embodiments of the present disclosure, the direct feedback can be in the form of upvotes or downvotes demonstrating approval or disapproval of current contributions by another participant in the conference call. Scoring module 278 can use this direct feedback in calculating a new score for the participant that is the subject of the direct feedback.

In some embodiments of the present disclosure, the source of the feedback can influence the score update applied by scoring module 278. For example, feedback from a participant who is a vice president or executive can result in a more substantial score change than feedback from a participant who is an entry-level employee. Moreover, the relative scores of participants can drive the amount of the score change applied by scoring module 278. For example, if a participant has a higher current score than another participant, than feedback from the participant can have a larger impact on score changes than feedback from the other participant. Additionally scoring module 278 can consider the expertise level of the various participants when determining score changes. For example, positive feedback from an expert participant can be given more weight by scoring module 278 than negative feedback provided by one or more participants who are not experts in the subject matter under discussion. Moreover, scoring module 278 can interpret the expert feedback as affecting the substantive aspect of a contribution to the conference call while simultaneously interpreting the negative feedback from non-experts as related to the manner or tone of the contribution. Accordingly, scoring module 278 can consider both positive and negative feedback for the same contribution, analyze the source of the feedback, and adjust the score accordingly.

Scoring module 278 can also base scoring decisions on the absence of data. For example, scoring module 278 can identify a participant who has not contributed to the conference call and can decrease that participant's score. In this way, scoring module 278 can continually decrease the score of a participant that does not provide any contribution to the conference call. This decrease in score can cause participants who are not contributing to engage in the conference call. Scoring module 278 can also view a lack of feedback from a participant as a lack of activity. For example, scoring module 278 can decrease the score of an individual who has not provided any explicit feedback. Accordingly, in some embodiments, scoring module 278 can decrease a score for a participant for not providing explicit feedback even if the participant has received score increases for other activity.

In some embodiments of the present disclosure, communication devices (e.g., communication devices 202A-202N and 204A-204N) can indirectly measure participant's reactions to contributions to the conference call providing implicit feedback from the participant. For example, the communication devices that are equipped with a camera (e.g., camera subsystem and optical sensor) can use facial recognition techniques to interpret a participant's reactions to what is being presented in a conference call. In this example, laughter or smiling can be interpreted as a positive reaction. The positive reaction can be transmitted by the communication device to scoring module 278 via communication server 228 and used to adjust the score of the participant eliciting the reaction. Similarly, the camera can be used to monitor behavior and the system can use this to detect disapproving reactions by a participant, such as recognizing a face palm gesture or other negatively connoted gesture by the participant. A negative reaction can likewise be transmitted by the communication device to scoring module 278 via the communication server 228 and used to negatively adjust the score of the participant eliciting the negative reaction.

Additional sensors (e.g., a motion sensor, a light sensor, a proximity sensor, a biometric sensor, etc.) can provide additional feedback and indications of a participant's reaction to the conference call. For example, a biometric sensor can record changes in heart rate, a motion sensor can record specific gestures or motions, an audio subsystem can record audible reactions such as laughter. The readings from sensors can be interpreted separately or in combination to determine the resulting reaction of the participant being measured. For example, audio analysis can be used to detect scoring cues such as participant laughter, requiring no analysis of visual data using computer vision or facial recognition techniques. Furthermore, certain participant gestures can be detectable by analysis of the audio that can be undetectable merely from analysis of the conference call video streams or other inputs, such as throat clearing gestures, sighing, breathing affectations, tone of voice, specific patterns in speech, and others. Moreover, the sensors can exist in separate devices associated with the same participant. For example, the participant's multimedia electronic device can monitor audio while a smart watch or other wearable device can measure motion.

Biometric sensors of a communication device can read both physiological and behavioral characteristics. Physiological metrics can include, among other things, facial recognition, odor or scent recognition, perspiration measurements, electrodermal activity (“EDA”), iris or retina measurements, or other measurements of physiological responses to information. Behavioral characteristics can include, among other things, typing rhythm, gait, vocal fluctuations, hand gestures, and/or physical mannerisms. Interpretations of these biometric events can result in an implicit approval or disapproval of the activity in the conference call.

Communication server 228 can provide scoring module 278 with a stream of events related to an ongoing conference call. This stream can include the previously described explicit and implicit data from the communication devices 202A-202N and 204A-204N as well as raw sensor data (e.g., data from a proximity sensor, a light sensor, a motion sensor, a biometric sensor, and/or other sensor(s)). The scoring module 278 can further interpret received event data to make scoring adjustments for the conference call participants. As events are acquired from the stream, scoring module 278 can dynamically update the scores of the participants of the conference call as the conference call progresses. Scoring module 278 can store the updates in database 276 and/or provide the score changes to other components of productivity server 232 such as analysis module 280, recommendation module 282, and user interface server 284.

Analysis module 280 can further process scoring data using statistical analysis and other methods to search for trends and patterns in the conference call data. Analysis module 280 can provide charts and statistics to user interface module 284 for display. Analysis module 280 can also analyze conference call data for patterns and correlations that can impact conference call outcomes.

Analysis module 280 can provide statistical analysis of an ongoing conference call. This analysis can be reviewed after the conference call, or the analysis can be visualized and provided to user interface module 284 for display as the conference call is taking place (e. g., in real-time). In some embodiments of the present disclosure, the visualization can be in the form of a chart, graph, raw data, highlights, or other statistical visualizations. The visualization can enhance the experience for those participating in the conference call and provide insight into the conference call dynamics. For example, analysis module 280 could provide a chart of the top contributors in the conference call, the participants who have increased or decreased their score the most, or the participants who have contributed the most feedback. It is readily apparent that more advanced statistical analysis can be performed and visualized for an ongoing conference call. Moreover, the analysis and trend data can be stored (e.g., in database 276) for later interpretation and review.

Analysis module 280 can analyze past conference call data and be trained to recognize reoccurring patterns or behaviors that affect a conference call. Based on this data, recommendation module 282 can provide comments, recommendation, suggestions or tips to user interface module 284 for display. These suggestions or tips can help improve the efficiency, efficacy and productivity of the conference call based on interactions that have occurred in past conference calls.

As more and more conference calls are analyzed, the training of analysis module 280 can improve leading to better suggestions and future analysis. This analysis can provide a mechanism by which effective, satisfying, and productive conference calls can be more consistently achieved through monitoring of the various participants' contributions within conference calls, correlating patterns of contribution to successful conference call outcomes, and subsequently modulating participant behavior through incentives such as scoring, rewards, badges, and other mechanics of gamification, to steer the pattern of a conference call towards those patterns that have been found to correlate to positive and productive outcomes.

For example, analysis module 280 can determine when a threshold number of participants disapprove of a specific topic or presenter. In this example, analysis module 280 can recognize the situation based on trained data or on an inherent analysis and provide a suggestion to the participants to shift to a different topic of discussion. In this way analysis module 280 can assist with maintaining more focused and effective conference calls. In another example, analysis module 280 can determine that a threshold level of tension has been breached in the interactions between participants in a conference call. In this example, analysis module 280 can recognize the situation based on trained data or on an inherent analysis and provide a suggestion to the participants to lighten the tone of the interactions, introduce levity into the interactions, and/or temporarily pause or suspend the conference call. In such an event, a participant who is effectively able to bring levity to the conference call through a next contribution may be rewarded by a positive adjustment to their score by scoring module 278.

The recommendation module 282 can acquire data from, among other sources, scoring module 278, analysis module 280, database 276, and data sources (not illustrated). In some embodiments of the present disclosure, data can first be filtered and processed by, for example, scoring module 278 or analysis module 280 before consumed by recommendation module 282. Recommendation module 282 can combine analysis from analysis module 280, scoring and contextual information from scoring module 278, and other internal data to make recommendations for future and ongoing conference calls. Recommendation module 282 can examine interactions between participants, conference calls on particular types of subject matter, and other types of interactions and information to provide recommendations for improving conference calls.

In some embodiments of the present disclosure, recommendation module 282 can perform general behavioral analysis on existing conference calls. This analysis can, in some embodiments, provide insights into the chemistry and interactions between various participants and topics. For example, two particular participants can fundamentally disagree on a specific topic leading to a deadlocked decision-making process. Recommendation module 282 can, in those embodiments, suggest only including one of the two participants based on, for example, which one has more relevant experience or expertise for the specific conference call, in order to facilitate a more productive conference call. In these embodiments, recommendation module 282 can rely on contextual information about the participants and the conference call in making appropriate recommendations on who should be included. For participants with limited availability and/or who may be experts on specific subjects, recommendation module 282 can utilize information related to resource availability and participant availability and/or schedules to effectively balance the demand of different conference calls on resources and individuals, so as to not benefit certain conference calls at the expense of others. In this way, recommendation module 282 can ensure that conference calls contain an effective mix of participants and that a conference call includes no more subject matter experts than truly necessary. Similarly, recommendation module 282 can ensure that a conference call includes a sufficient amount of subject matter experts to allow for an effective conference call. Recommendation module 282 can also use resource and individual availability information to achieve specific outcomes where conference calls can be balanced with a complement of more skilled and lesser skilled participants. In this way, recommendation module 282 can allow lesser skilled participants to gain exposure to more skilled participants and learn through interaction with more skilled participants, and recommendation module 282 can ensure that a conference call is not biased too heavily towards highly or lightly skilled participants while other conference calls are biased too heavily in the opposite direction.

Similar to analysis module 280, recommendation module 282 can be trained using traditional machine learning techniques. The results of past recommendations and conference calls can be used as a training set to improve the effectiveness of future recommendations.

User interface module 284 can receive information from, among others, scoring module 278, analysis module 280, and recommendation module 282. Based on this information, user interface module 284 can generate updates. The updated user interface can be provided to the communication server 228 for distribution to the communication devices 202A-202N and 204A-204N. It is appreciated that the user interface changes can include full frames or delta values that represent only the information on the interface that has changed.

As scores for individual participants change, user interface module 284 can dynamically modify the user interface elements that represent specific participants to convey the changes in score. In some embodiments of the present disclosure, user interface module 284 can provide charts, graphs, or other data provided by analysis module 280 for display on the communication devices 202A-202N and 204A-204N. Moreover, in some embodiments of the present disclosure, user interface module 284 can provide suggestions generated by analysis module 280 and recommendation module 282.

As more data is processed by the various components of productivity server 232 (e.g., scoring module 278, analysis module 280, and/or recommendation module 282) user interface module 284 can constantly update the conference user interface to reflect the updated data. In some embodiments of the present disclosure, user interface module 284 will change in a manner to emphasize those participants deemed to be providing the most positive contributions to the conference call. In this way, user interface module 284 can attempt to encourage other participants to improve their participation in an effort to earn the recognition being provided and the increase the productivity score of the participant as well as the productivity score of the conference call. This feature of the conference user interface can help encourage behavior that positively affects a conference call resulting in higher quality conference calls. Moreover, this feature can create inherent competition among the participants to provide better contributions to the conference call.

In some embodiments of the present disclosure, the conference user interface displays a representation of a participant's score through, for example, a number, a level bar widget, or other indicator. Additionally, the conference user interface can display badges, banners, alternative score indicators, or other indicators of an achievement of a participant. For example, a participant who elicits laughter can earn specific levity points that can be displayed on the conference user interface using a separate levity bar or levity score number. In some embodiments of the present disclosure, these types of specific achievements can be represented by badges, icons, or other indicators specific to causing laughter. Additionally, the conference user interface can utilize sound, animations, or other indicators to represent changes to, among other things, a participant's score, badges, status, and/or achievements. In some embodiments of the present disclosure, the conference user interface can utilize additional indicators to represent accolades earned in past conference calls. In some embodiments of the present disclosure, achievements, badges, banners, or other identifiers from previous conference calls follow a participant to future conference calls so that participants can begin new conferences with achievements, banners, badges, or other awards earned in past conferences.

The conference user interface can further utilize a plurality of visual techniques to represent the scores for the conference participants including highlighting the higher scoring participants by means of some forms of graphical filters, such as by making the higher scoring participants appear in color while lower scoring participants can appear in gray scale. The conference user interface can further provide color coded borders or overlay icons to indicate relative scores, classes of scores, or scoring ranks. Additionally, the conference user interface can utilize graphical badges or trophies to indicate achievements and actual scores using visual indicators, such as score numbers or value bars.

In some embodiments of the present disclosure, updates generated by user interface module 284 can account for the variety of communication devices 202A-202N and 204A-204N that can connect to communication server 228. In some embodiments of the present disclosure, user interface module 284 can provide different user interface updates to the communication devices 202A-202N and 204A-204N that are specific to the characteristics of each device.

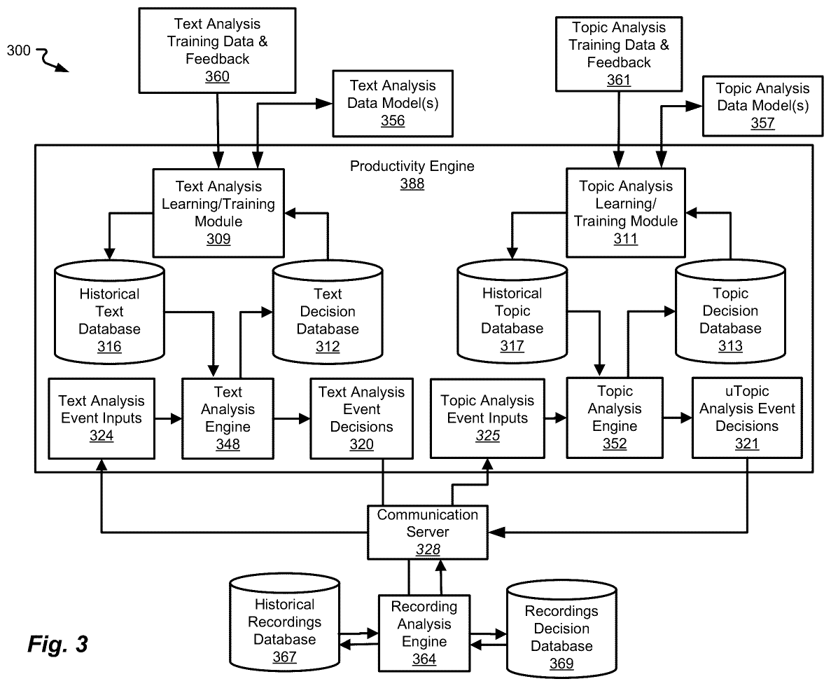

FIGS. 4A and 4B are block diagrams illustrating example communication session user interfaces 401 and 402, respectively, in accordance with at least some embodiments of the present disclosure. For example, FIG. 4A represents a user interface 401 on a mobile device (e.g., communication device 202N shown in FIG. 2A), or a tablet device. FIG. 4B represents the same user interface 402 at a later point in time as modified by productivity server 232 and user interface module 284. In FIG. 4A, avatars 411, 412 and 421-424 can represent participants in the communication session. Each avatar is associated with a participant. These avatars can be a static drawing, picture of the corresponding participant, or video and/or audio feeds of each participant. In addition to the elements shown in FIGS. 4A and 4B, the communication session user interfaces 401 and 402 can include additional widgets, indicators, and/or other user interface elements. In some embodiments of the present disclosure, the communication session interfaces 401 and 402 contains less than that shown in FIGS. 4A and 4B.

In the example embodiment of FIG. 4A, avatars 411 and 412 are larger than the remaining avatars. In some embodiments of the present disclosure, visual enhancement techniques, such as, for example, foreground or background highlighting, pulsating, and/or shading, can provide more visual prominence to the avatars 411 and 412. The relative size of the avatars can represent the relative scores associated with the participants represented by each avatar. For example, as shown in FIG. 4A, the participants represented by avatars 411 and 412 can have a higher score (i.e., a higher participant meeting parameter productivity score) than the remaining participants. In this example, avatars 411 and 412 can represent two participants with the same score. In some embodiments of the present disclosure, FIG. 4A can represent the initial layout for a communication session. In these embodiments, the size of avatars 411 and 412 can indicate that the associated participants have a higher initial score based on past conference calls, have particular expertise relative to the other participants, or have a higher score due to their relative position in the company.

FIG. 4B can represent the same user interface 402 depicted in FIG. 4A at a later point in time. As shown in reference to FIG. 4B, as the communication session progresses, the scores change. As shown in FIG. 4B, avatar 411 can increase in size due to a higher score by the participant associated with avatar 411. Conversely, avatar 412 can shrink representing a decrease in score by the participant associated with that avatar. Similarly, avatars 421-424 can shrink in size to show a reduction in score by the participant associated with those avatars. Thus, changes to the avatars can demonstrate both active participation and also inactivity from the participants. In some embodiments of the present disclosure, as the communication session progresses, initial score determinations become less relevant as score updates from scoring module 287 result in adjustments to the user interface. Dynamic changes to the displayed avatars can occur constantly over the course of the communication session. In some embodiments of the present disclosure, many or all of the elements are constantly updated in real-time providing a fluid display that is rapidly changing to show various aspects of participant activity. Updates to the communication session interfaces 401 and 402 can include changes in all of the displayed elements and is not limited to just the avatars as discussed below with respect to FIGS. 4C and 4D.

FIGS. 4C and 4D are block diagrams illustrating alternative example communication session user interfaces in accordance with at least some embodiments of the present disclosure.

For example, FIG. 4C represents a user interface 403 on a mobile device (e.g., communication device 202N shown in FIG. 2A), or a tablet device. FIG. 4D represents the same user interface 404 at a later point in time as modified by productivity server 232 and user interface module 284. In FIGS. 4C and 4D, the avatars are replaced with bars of a chart or graph 450 and 460 that represent participants in the communication session. Each bar on the graph is associated with a participant. These bars illustrate the level of participation generated for the participant meeting parameter productivity score.

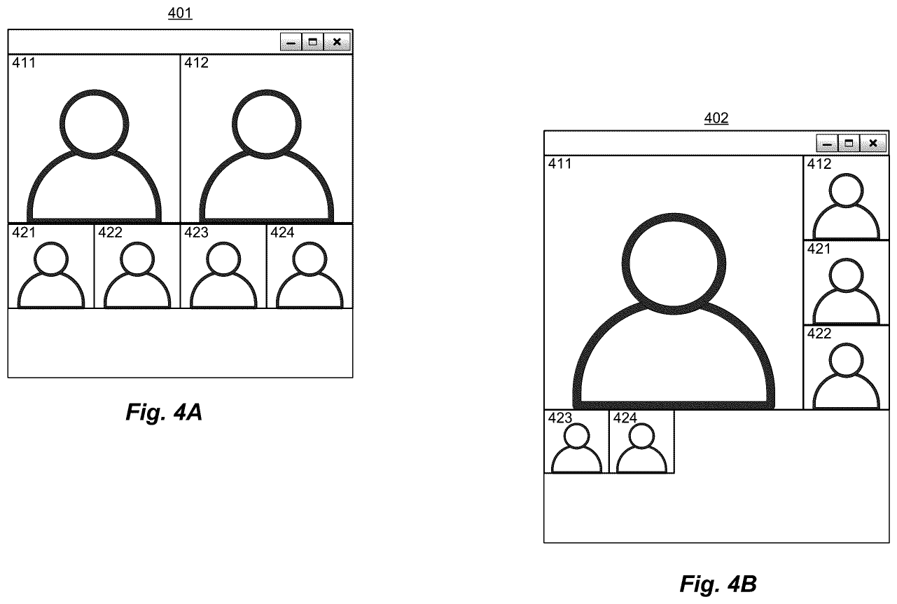

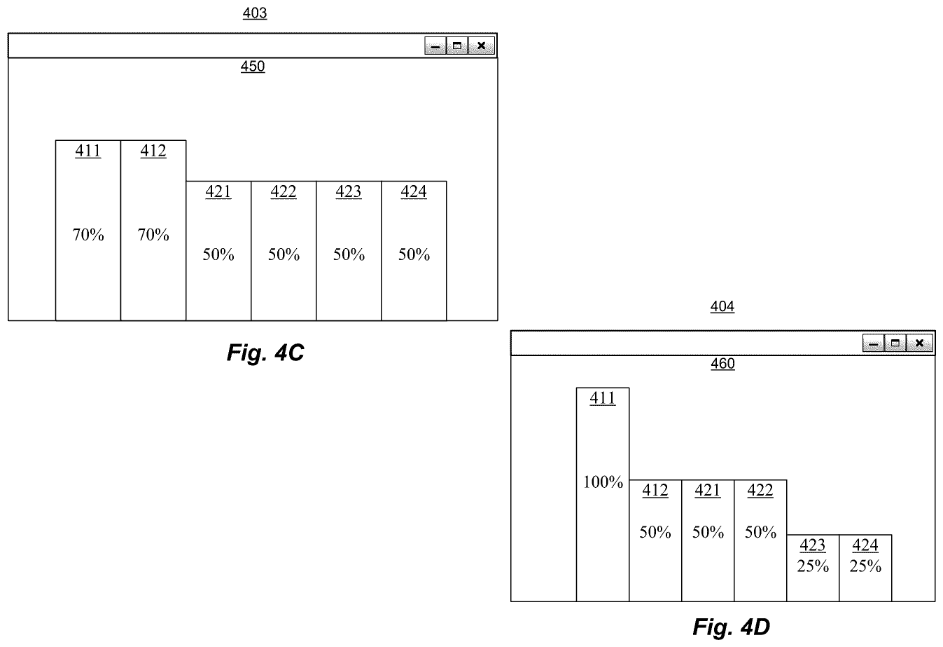

FIGS. 5 and 6 are block diagrams illustrating example communication session user interface screenshots in accordance with at least some embodiments of the present disclosure. As illustrated in FIG. 5, screenshot 500 shows a situation where an individual participant's meeting parameters may include speaking time 501, connectivity factor 502, email 503, and time away from PC 504. Assume, in this example, that the participant is a remote worker dialing into a meeting, and that the participant wishes to ensure that their voice is heard, and that they are not multitasking too much or walking away entirely. For each meeting parameter, a shaded portion of the horizontal line or bar indicates intervals when the corresponding activity was detected during the session, as well as a percentage of the time the user spent on that particular activity. An indication of a total, overall productivity score 505 may be provided along with an indication of whether the current score is higher or lower than a previous score or average.

As the communication session progresses, productivity score 505 may be reduced based, at least in part, upon a lack of a selected engagement activity for a predetermined period of time. Additionally, or alternatively, productivity score 505 may be increased based, at least in part, upon an improvement of a selected engagement activity for a predetermined period of time.

In some cases, productivity score 405 may be a weighted sum of engagement meeting parameters 501-504 using a weight value assigned to each such metric. These weight values may be preset, selected by a session organizer, or selected by each individual participant. Additionally, or alternatively, weight values may be assigned to an engagement metric depending upon context. For example, if a participant is physically disposed in proximity to another participant of the virtual collaboration session, looking away from the device's screen and toward the other participant does not necessary represent a negative or disengaged interaction. As another example, if a participant has typed a keyword into an application that has been spoken during the virtual collaboration session, such an action may also represent a positive or engaged activity.

FIG. 6 is generally similar to FIG. 5, but screenshot 600 shows another individual participant's meeting parameters include speaking time 601, email 602, web browsing 603, and engagement score 604. Here, assume that the participant is a worker meeting with others in a conference room. As was the case with the remote worker, here the local participant is also concerned about having his voice heard, but he has a tendency to email too much during meetings. Note that the participant tends to use email much of the time and only breaks to talk. As such, the participant may use the tool to become aware of these habits and sets goals to improve over time. Also, it should be noted that in this example both the participant of screenshot 500 and the participant of screenshot 600 may be attending the same session, but each individual may have selected a different set of metrics to be considered. In other words, a participant may change a meeting parameter or a meeting parameter's weight depending upon the participant's personal preference for prioritizing a first activity over a second activity.

In some cases, screenshots 500 and/or 600 may be presented to a user in real-time during the entire virtual collaboration session. In other cases, engagement calculations may be performed as a background process and, in response to a determination that a meeting parameter has reached a corresponding, configurable threshold value, screenshots 500 and/or 600 may be presented to the respective user.

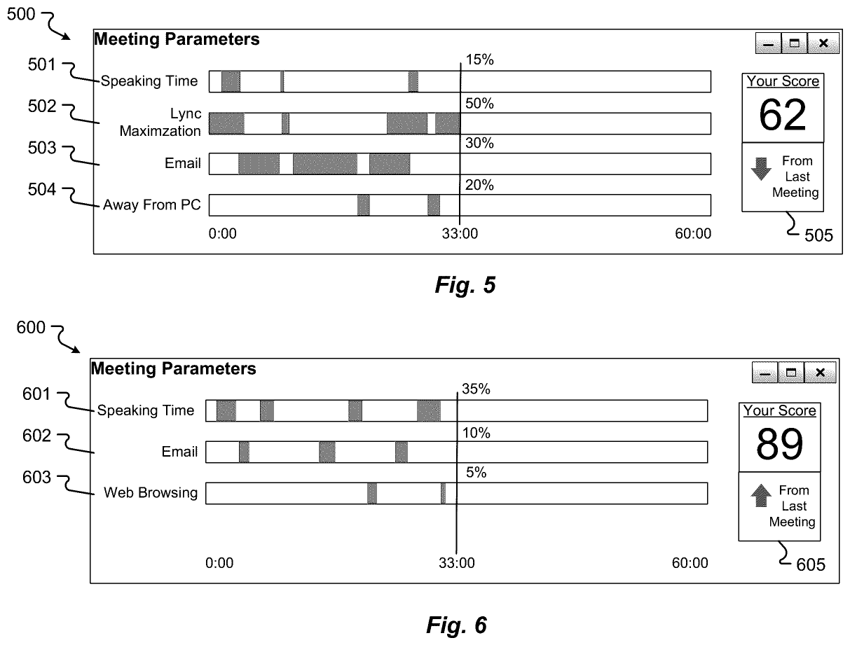

FIG. 7 is a block diagram illustrating an example communication session user interface screenshot for productivity data in accordance with at least some embodiments of the present disclosure. Specifically, portion 701 of screenshot 700 shows information about a particular virtual collaboration session including the topic, the default project repository (here named “Connected Productivity,” a list of participants, an indication of the most used conference room that is available, and the date of the last meeting.

Portion 702 of screenshot 700 shows overall meeting parameters regarding participation, engagement, follow through, and decisions. In this case, participation data indicates that 25% of invitees consistently attend sessions, engagement data indicates that 75% of attendees actively participate in sessions, follow through data indicates that 30% of participants regularly complete action items, and decision data indicates that 10% of sessions include a decision made during the session. Meanwhile, portion 703 indicates a recommendation that the meeting organizer consider reducing the frequency of sessions to once every other week. In some cases, suggestion 703 may be reached based upon an automated analysis of data shown in portion 702, each of which may have its own assigned weight (similarly as with purely individual engagement metrics).

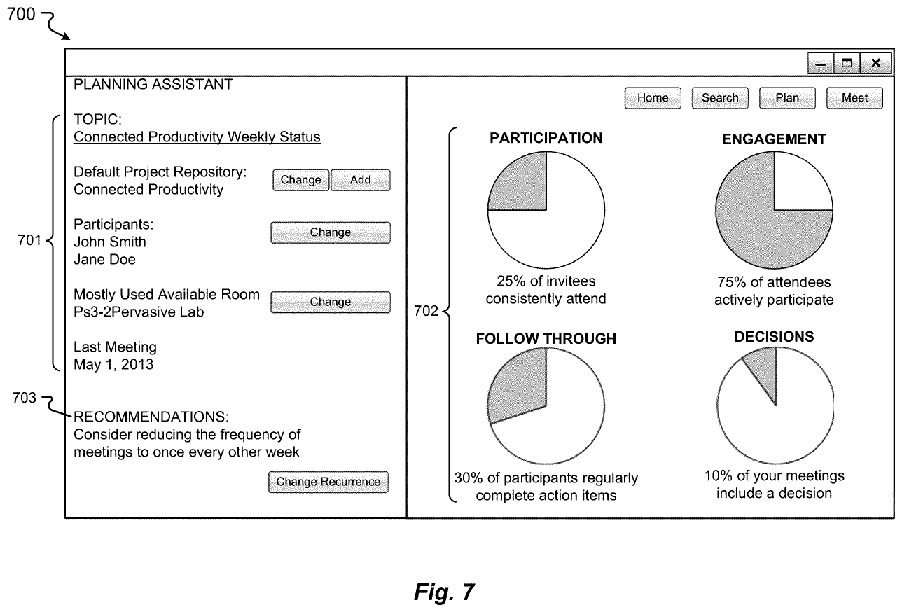

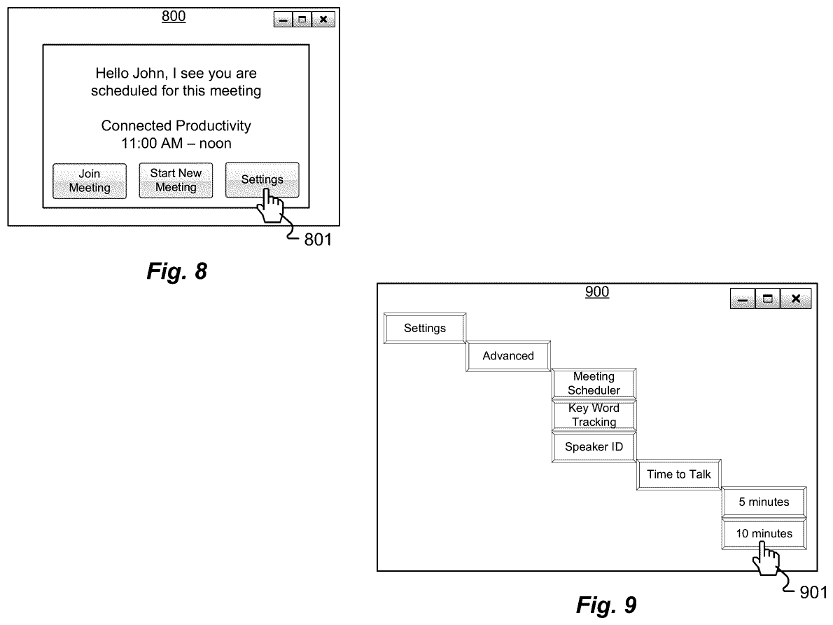

In some cases, a service may be invoked by a user(s) serving as the meeting or session initiator. The meeting initiator can make use of the meeting host computing device to access the user interfaces, prior to or at the start of a meeting, and to select options for meeting timing events. To illustrate this, FIGS. 8 and 9 are screenshots illustrating systems for managing session and/or topic time limits according to some embodiments. In FIG. 8, screenshot 800 shows a user interface displayed to a meeting initiator 801, which includes controls for joining a meeting, starting a new meeting, or entering settings for a meeting.

In FIG. 9, screenshot 900 shows an example of hierarchical settings selectable by initiator 801. In this example, advanced settings include a meeting scheduler, keyword tracking, or speaker identification. These settings may range from timing events (e.g., post countdown to scheduled meeting-end with variable interval setting) to context driven events. For instance, the meeting schedule setting may allow the initiator to set a hard-stop indicator whereby the timing engine makes use of meeting information provided by the calendaring tool to warn either the initiator or any participant of upcoming hard-stop events, such as the imminent losing of the meeting room or the start of a subsequent higher priority event. In some cases, however, the initiator may also be warned of other, non-hard-stop events such as, for example, certain preselected meeting warnings, personal coaching suggestions being issued (e.g., a warning when time spent on a specific slide, which indicative time spent on a single topic, is about to be exceeded), etc.

In some cases, the meeting schedule setting may also include an end-of-topic warning feature whereby the timing engine makes use of agenda information provided by calendaring to enforce time limits for individual topics. Tracking of individual topic transitions for timing purposes may enforced, for example, by pre-tagging presentation slides with “topic tag-words” that are detectable through the meeting host UI or by pre-assigning key words to topics that may be matched through automatic speech recognition or similar techniques.

The keyword tracking setting may be configurable to allow the tracking of repetitive keywords and to proactively present a warning when a threshold amount of keyword usage is reached or exceeded (e.g., “meeting time limit at risk”). In some cases, tracking keywords that are selected for their relationship to specific topics may provide an indication that too much discussion has been spent on a given topic. Additionally, or alternatively, the absence of specific keywords can be used as an indication that a high priority topic has not been covered. Also, keywords may be assigned by a meeting initiator, may be automatically collected from agenda/topic list, or from a list logged from previous but related virtual collaboration session. Moreover, threshold usage may be set for total meeting time or per meeting topic.

The speaker ID option allows the initiator to select a time-to-talk (TTT) feature, whereby initiator may select a predetermined amount of time to be allocated to a particular speaker or session participant. A notification may then be provided to warn a meeting initiator or the speaker when the limit is about to be reached.

Once the meeting initiator has started the meeting, timing control is passed to the meeting host. The meeting host makes use of set-up options, meeting information and context to post warnings when time limits are about to be exceeded. The meeting initiator may interrupt the meeting host through user interface to move to end the meeting, to move to the next topic or to change meeting settings.

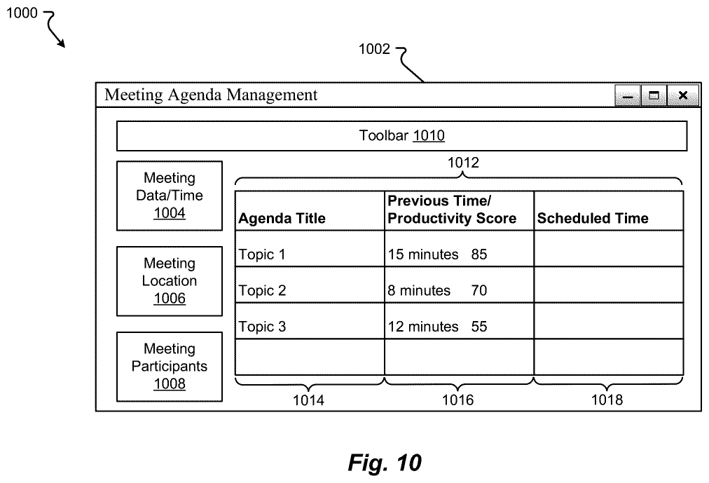

FIG. 10 is a diagram illustrating an example communication session user interface 1000 for scheduling an agenda for a communication session and having previous meeting statistics available, in accordance with at least some embodiments of the present disclosure. According to one illustrative embodiment of the present disclosure, communication session user interface 1000 allows a user to plan a meeting. The communication session user interface 1000 may include a window 1002 which will allow the user to interact with various features of the system. These features may include, among others, meeting information such as date and time 1004, meeting location 1006 and intended meeting participants 1008. The features included in the window may further include, an agenda table 1012 having a column 1014 for an assigned title of an agenda topic, a column 1016 for the previous amount of time allocated to the associated agenda topic and the associated productivity score, and a data field column 1018 allowing a user to schedule an amount of time for each agenda item. Features within the window may further include a toolbar 1010. The toolbar 1010 may include a variety of features which may be standard for computer program applications.

Various pieces of information about past meetings and their recorded times can be useful when scheduling a meeting. For example, if the date and time 1004 of meetings are recorded along with the time spent on those meetings, statistical data indicating how the date and time affects the average time of a meeting may be formed. It may be the case that meetings generally take longer in the morning. It may also be the case that meetings held on Monday generally take longer than meetings held on Friday.

The meeting location 1006 may also affect the average amount of time needed to get through a meeting. Meetings may be held in a variety of locations. Some meetings are held in a room where all participants are present. Other meetings take place over videoconferences or teleconferences. It may be the case that a meeting with the same agenda items will generally take longer if done over a videoconference format than if done with all participants in the same room.

It may be possible that certain meeting participants 1008 will affect the average amount of time it takes to complete a meeting. For example, some people tend to be long winded. Having a long winded individual as a participant in a meeting may tend to increase the amount of time it takes to complete the meeting. Conversely, some people tend to push things along. Having a person who tends to push along the agenda may tend to decrease the amount of time it takes to complete a meeting.

By keeping track of certain information about a meeting including the date and time 1004, the meeting location 1006, and the meeting participants 1008 as well as the time required to complete those meetings, statistical data can be formed to indicate a how these factors tend to affect how long it takes to complete a meeting. By having a computerized meeting management system to maintain a record of the aforementioned information, this statistical data may be formed and updated regularly. A system or method embodying principles described herein is in no way limited to the recording of the above-mentioned information. A variety of other factors which may influence the average amount of time spent may be recorded as well.

The agenda of a meeting typically contains several items of business that need to be discussed. A window 1002 in the communication session user interface 1000 could have an agenda table 1012 in which a user could add agenda items to the meeting schedule. An agenda title column 1014 could display the title of the added agenda topics. Both new agenda topics and recurring agenda topics may be added to the schedule. An example of a recurring agenda topic would be a weekly sales report or a daily progress report. By recording the amount of time spent on individual recurring agenda topics as opposed to the entire meeting time, statistical data may be better targeted to certain aspects of a meeting. Because different meetings may include a mix of different recurring agenda topics, having statistical data relative to each agenda item will help a user accurately plan for an upcoming meeting. Any of the data mentioned above with regard to an entire meeting may also be tracked for individual agenda items.

If an agenda topic in the agenda topics column 1014 is recurring and has past statistics available, a previous time and a productivity score is provided in another column 1016. The suggested time could be based on the average amount of time spent on a particular agenda topic under similar meeting conditions in the past. A column 1018 may also be available for a user to enter the desired amount of scheduled time for each agenda item. A user may choose to follow the suggestion offered by the computerized meeting management system but may also choose to schedule an alternate amount of time.

The window 1002 of the communication session user interface 1000 may also include a toolbar 1010. The toolbar 1010 may contain a variety of features and operational functions associated with the computerized meeting management system. The toolbar may also allow users to access other aspects of the computerized meeting management system.

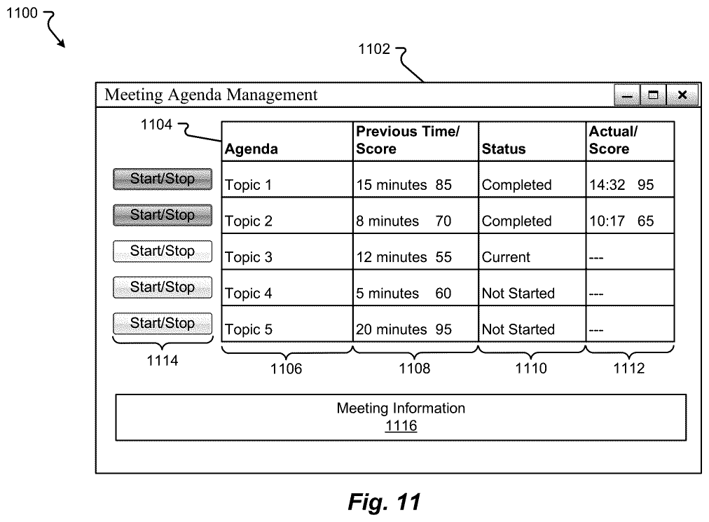

FIG. 11 is a diagram illustrating an example communication session user interface 1100 for recording the amount of time spent on topics within a meeting, in accordance with at least some embodiments of the present disclosure. According to one illustrative embodiment of the present disclosure, the communication session user interface 1100 could contain a window 1102 allowing the user to interact with various functions offered by the system relating to recording the amount of time spent on each agenda item. The window 1102 may include an agenda table 1104 having an agenda topic column 1106, previous time/productivity score column 1108, a status column 1110, and an actual time/productivity score column 1112. The window 1102 may also include controls 1114 allowing a user to indicate both start and stop times for each agenda topic. Additional meeting information 1116 may be displayed as well.

The communication session user interface 1100 illustrated in FIG. 11 may be used by a participant of a meeting during the actual meeting. The communication session user interface 1100 allows a user to keep track of the amount of time spent on each agenda topic. Each agenda topic may be displayed in the agenda table 1104. The agenda table 1104 may have an agenda title column 1106 displaying the title of each agenda item that has been scheduled for a meeting. The agenda table 1104 may also include a previous time/productivity score column 1108 indicating the amount of time that the meeting planner has allocated for each agenda topic as well as an associated productivity score. The agenda table 1104 may further include a status column 1110. The status column 1110 may indicate which agenda topics have already been completed, which one is currently being discussed, and which ones have not yet started. For every agenda item that has been completed, the actual amount of time spent on the completed agenda topic as well as an associated productivity score may be displayed in an actual time column 1112.

To indicate when the start and stop time for each agenda item of the meeting, the window 1102 may include a set of controls 1114. In one embodiment of the present disclosure, the set of controls 1114 could include a button for each agenda topic. The button may be used to indicate both the start time and the stop time of a particular agenda topic. The buttons may also be color coded. For example, one color could indicate completed agenda topics, one color could indicate the current agenda topic, and another color could be used to indicate agenda topics which have not yet been started.

By keeping track of the amount of time spent on each agenda topics and other meeting information, the statistics that are used to suggest an appropriate time to schedule for recurring agenda topics may be updated after every meeting. By updating the statistics every meeting, the computerized system will be able to provide a more accurate suggested time to the meeting planner. The exact mathematical formulas used to determine how various factors will influence the average time of various recurring agenda items may be any of a variety of formulae. Those skilled in the relevant art will be able to develop appropriate statistical models for any particular application to provide a suggested time for a meeting and the productivity of the meeting.

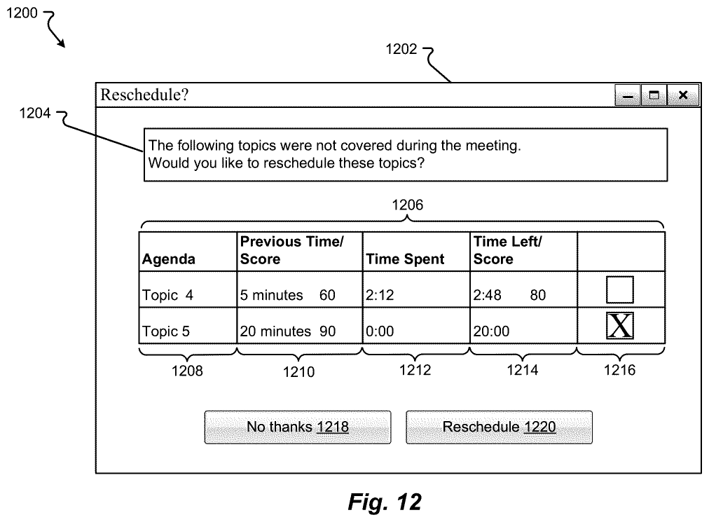

In addition to providing a suggested amount of time to schedule for recurring agenda topics, the computerized meeting management system may also provide other functions to meeting participants. For example, the meeting management system may automatically reschedule agenda items that were not completed during a previous meeting. FIG. 12 is a diagram illustrating an example communication session user interface 1200 for rescheduling incomplete topics from a meeting, in accordance with at least some embodiments of the present disclosure. According to one illustrative embodiment of the present disclosure, the system could cause a window 1202 to appear if all of the agenda items scheduled for a meeting were not completed. The window 1202 could include a text box 1204 asking the user if they want to reschedule the incomplete agenda topics. The window could also include an incomplete agenda topics table 1206 including an agenda topics column 1208, a scheduled time column 1210, a time spent column 1212, a time left column 1214, and a checkbox column 1216. The window 1202 may also include controls 1218, 1220 allowing the user to interact with the user interface 1200.

In some cases, a meeting will end right on schedule or prematurely because of an unexpected event whether or not all agenda topics were covered. The incomplete agenda topics table 1206 may include a list of all of the agenda topics that were not completed during the meeting's scheduled time. The agenda title column 1208 may list all of the incomplete agenda topics and any partially completed agenda topics. The scheduled time column 1210 could display how much time was originally scheduled for each incomplete agenda topic. A time spent column 1212 could display the amount of time that was spent on any partially complete agenda topics. A time left column 1214 could display how much time was allocated to an incomplete agenda topic minus the amount of time spent on the incomplete agenda topic. This may help the user determine if it is worthwhile to reschedule the agenda topic. A checkbox column 1216 may be used to allow a user to select which agenda topics to reschedule. It may be the case that a user wishes to reschedule only some of the incomplete agenda topics.

After a user has selected which incomplete agenda topics to reschedule, the user may use various controls associated with the window 1202 to indicate an action. For example, there could be a reschedule button 1220 which, when activated, will automatically reschedule the incomplete agenda topics selected in the checkbox column 1216. There could also be a “no thanks” button 1218 which, when activated, will close the window and not reschedule any of the incomplete agenda topics.

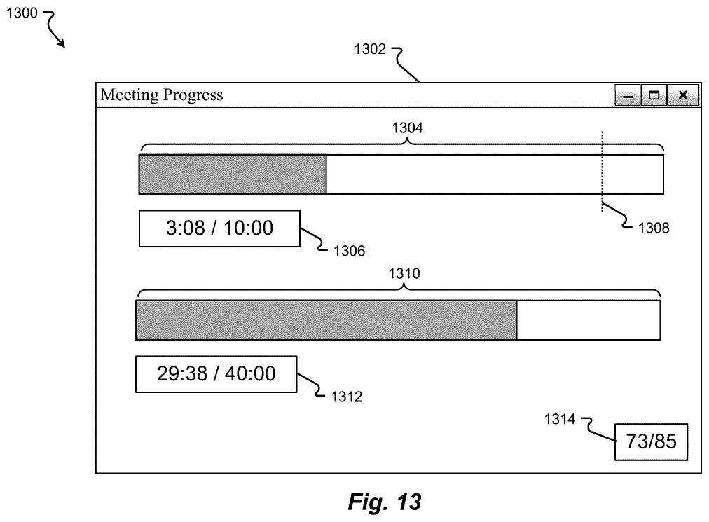

One function which may be provided by the computerized system is to display to a user, the progress of a meeting or agenda topic. FIG. 13 is a diagram illustrating an example communication session user interface 1300 for displaying to a user the current progress of a meeting, in accordance with at least some embodiments of the present disclosure. According to one illustrative embodiment of the present disclosure, the user interface 1300) may include a window (1302). The window 1302 may include both a current agenda item progress bar and a total meeting progress bar 1310.

A current agenda item progress bar 1304 may graphically display the amount of time spent on the current agenda topic relative to the total amount of scheduled time. The amount of time spent on the current agenda topic may also be displayed digitally in a current agenda digital time box 1306. In one embodiment of the present disclosure, the computerized meeting management system could be configured to notify a user that the time is approaching the end of the scheduled time for a particular agenda. This notification may take place through a variety of means including, but not limited to, a flashing light or a beeping sound. The current agenda item progress bar 1304 could have a reminder line indicating when the reminder will be given.

A total meeting progress bar 1310 may graphically display the progress of the entire meeting. The current meeting progress may also be displayed digitally by a total meeting digital time box 1312. In one embodiment of the present disclosure, the total meeting progress could also be displayed as a percentage over the productivity score 1314. Having the progress of the meeting and its agenda topics being graphically displayed may assist meeting participants in holding to the schedule of the meeting.

In one embodiment of the present disclosure, the current agenda item progress bar 1304 or the total meeting progress bar 1310 may be color coded. For example, if the progress of the meeting is maintaining its original schedule, the progress bar 1304, 1310 may be green. If an agenda item or meeting has exceeded its allotted time, the progress bar 1304, 1310 may be red.

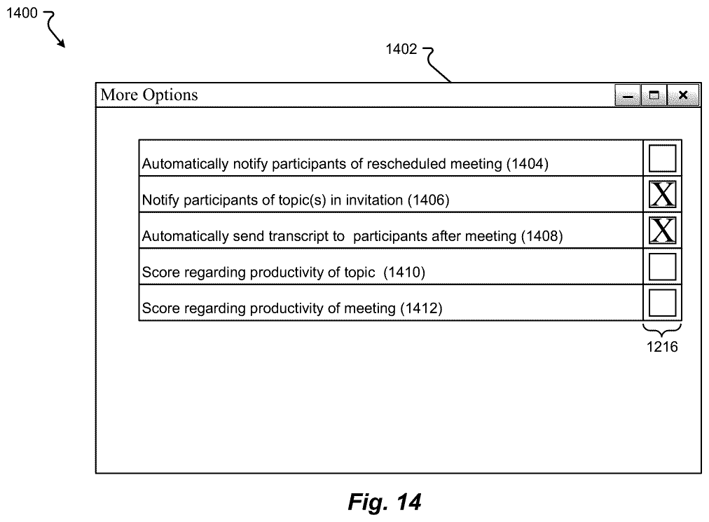

The computerized meeting system may also include other functions to assist with the planning and management of a meeting. FIG. 14 is a diagram illustrating an example communication session user interface 1400 for applying additional features to meeting topics, in accordance with at least some embodiments of the present disclosure. According to one illustrative embodiment of the present disclosure, the user interface 1400 may include an options window 1402. The options window 1402 may include a list of various features which may be selected through a checkbox 1414 by a user. The features may include, among others, whether or not to automatically notify participants of a rescheduled meeting 1404, notify participants of the agenda topics on the schedule 1406, send a transcript of the meeting to participants after the meeting 1408, scores regarding productivity of topics 1410, and to scores regarding productivity of meeting 1412.

A user may have the option to automatically notify participants of an automatically rescheduled meeting 1404 that results when agenda items are incomplete. As mentioned above, the identity of all participants in a meeting may be stored with a computerized meeting management system. If the option to notify participants of a rescheduled meeting is selected, an email, text or other message could be automatically sent to the participants indicating the date, time, and location of the rescheduled meeting.

A user may also have the option to notify participants of the agenda topics 1406 that will be discussed in an upcoming meeting. With this option selected, when a meeting coordinator sends out meeting invitations to meeting participants, the meeting invitation may list the agenda items which are scheduled for the meeting associated with the invitation.

A user may also have the option to automatically send a transcript to the meeting participants after the meeting 1408. With this option selected, the participants may be emailed a transcript of the meeting sometime after the meeting has ended. The meeting may be recorded by a standard audio recording device. Either a digital audio file or a text copy transcribed from the digital audio file may be sent to the participants.

In one embodiment, statistical data recorded from a meeting agenda may be recorded from an offline terminal. An offline terminal may be any device not currently maintaining a data connection with the computerized meeting management system. When the terminal is online again, that is, a data connection is made, the statistical data recorded may be synched with the computerized meeting management system to bring the statistical data up to date. Any other changes or updates made from the offline terminal may also be synchronized when the terminal is online again.

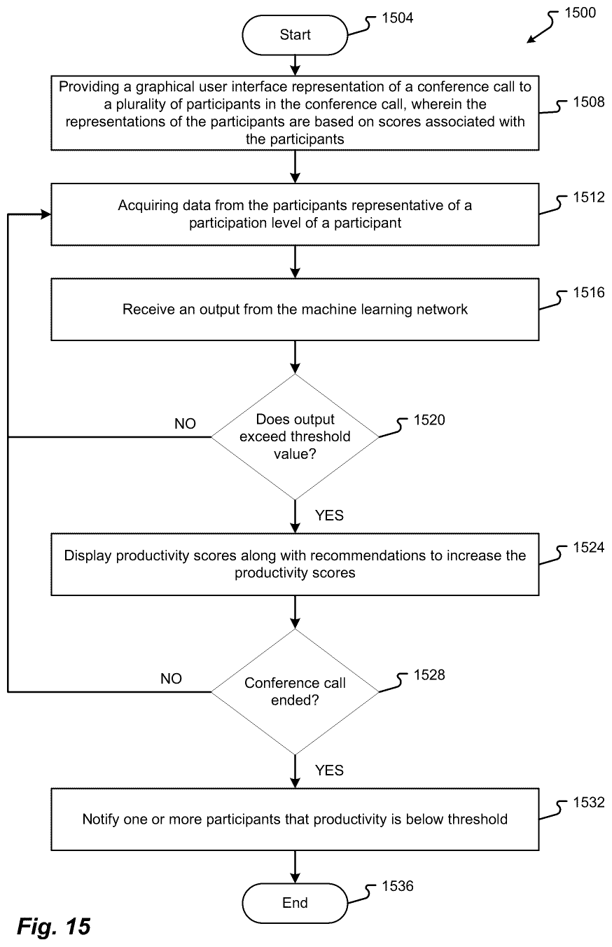

FIG. 15 is a flowchart of an example process for measuring the productivity of communication sessions and using the measured productivity to improve future communication sessions in accordance with at least some embodiments of the present disclosure. While a general order of the steps of method 1500 is shown in FIG. 15, method 1500 can include more or fewer steps or can arrange the order of the steps differently than those shown in FIG. 15. Further, two or more steps may be combined into one step. Generally, method 1500 starts with a START operation at step 1504 and ends with an END operation at step 1536. Method 1500 can be executed as a set of computer-executable instructions executed by a data-processing system and encoded or stored on a computer readable medium. Hereinafter, method 1500 shall be explained with reference to systems, components, modules, software, data structures, user interfaces, etc. described in conjunction with FIGS. 1-14.

Method 1500 may begin at START operation at step 1504 and proceed to step 1508, where the processor 236 of the productivity server 232 provides a graphical user interface representation of a conference call to a plurality of participants in the conference call, wherein the representations of the participants are based on scores associated with the participants. After providing a graphical user interface representation of a conference call to a plurality of participants in the conference call, wherein the representations of the participants are based on scores associated with the participants, at step 1508, method 1500 proceeds to step 1512, where the processor 236 of the productivity server 232 acquires data from participants representative of a participation level of a participant. After acquiring data from participants representative of a participation level of a participant at step 1512, method 1500 proceeds to step 1516, where the processor 236 of the productivity server 232 receives an output from a machine learning network. After receiving an output from a machine learning network at step 1516, method 1500 proceeds to decision step 1520, where the processor 236 of the productivity server 232 determines if the output exceeds a threshold value. If the output does not exceed a threshold value (NO) at decision step 1520, method 1500 returns to step 1512. If the output does exceed a threshold value (YES) at decision step 1520, method 1500 proceeds to step 1524, where the processor 236 of the productivity server 232 displays productivity scores along with recommendations to increase the productivity scores.

After displaying productivity scores along with recommendations to increase the productivity scores at step 1525, method 1500 proceeds to decision step 1528, where the processor 236 of the productivity server 232 determines if the conference call has ended. If the conference call has not ended (NO) at decision step 1528, method 1500 returns to step 1512. If the conference call has ended (YES) at decision step 1528, method 1500 proceeds to step 1532 where the processor 236 of the productivity server 232 notifies one or more participants that the productivity is below a threshold value. After notifying one or more participants that the productivity is below a threshold value at step 1532, method 1500 ends with END operation at step 1536.

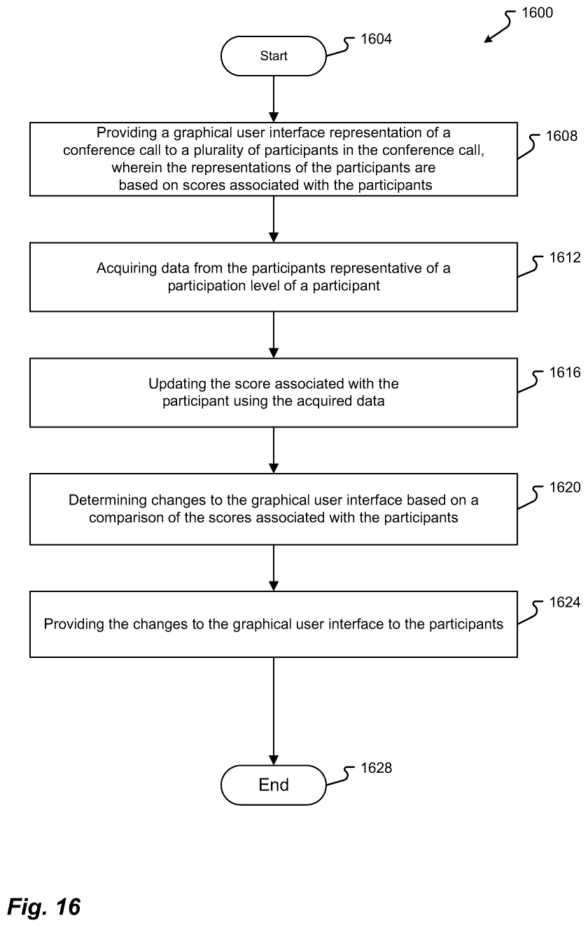

FIG. 16 is a flowchart of an example process for measuring the productivity of communication sessions and using the measured productivity to improve future communication sessions in accordance with at least some embodiments of the present disclosure. While a general order of the steps of method 1600 is shown in FIG. 16, method 1600 can include more or fewer steps or can arrange the order of the steps differently than those shown in FIG. 16. Further, two or more steps may be combined into one step. Generally, method 1600 starts with a START operation at step 1604 and ends with an END operation at step 1628. Method 1600 can be executed as a set of computer-executable instructions executed by a data-processing system and encoded or stored on a computer readable medium. Hereinafter, method 1600 shall be explained with reference to systems, components, modules, software, data structures, user interfaces, etc. described in conjunction with FIGS. 1-14.

Method 1600 may begin at START operation at step 1604 and proceed to step 1608, where the processor 236 of the productivity server 232 provides a graphical user interface representation of a conference call to a plurality of participants in the conference call, wherein the representations of the participants are based on scores associated with the participants. After providing a graphical user interface representation of a conference call to a plurality of participants in the conference call, wherein the representations of the participants are based on scores associated with the participants, at step 1608, method 1600 proceeds to step 1612, where the processor 236 of the productivity server 232 acquires data from participants representative of a participation level of a participant. After acquiring data from participants representative of a participation level of a participant at step 1612, method 1600 proceeds to step 1616, where the processor 236 of the productivity server 232 updates the scores associated with the participant using the acquired data. After updating the scores associated with the participant using the acquired data at step 1616, method 1600 proceeds to step 1620, where the processor 236 of the productivity server 232 determines changes to the graphical user interface based on a comparison of the scores associated with the participants. After determining changes to the graphical user interface based on a comparison of the scores associated with the participants at step 1620, method 1600 proceeds to step 1624, where the processor 236 of the productivity server 232 provides the changes to the graphical user interface to the participants. After providing the changes to the graphical user interface to the participants at step 1624, method 1600 ends with END operation at step 1628.

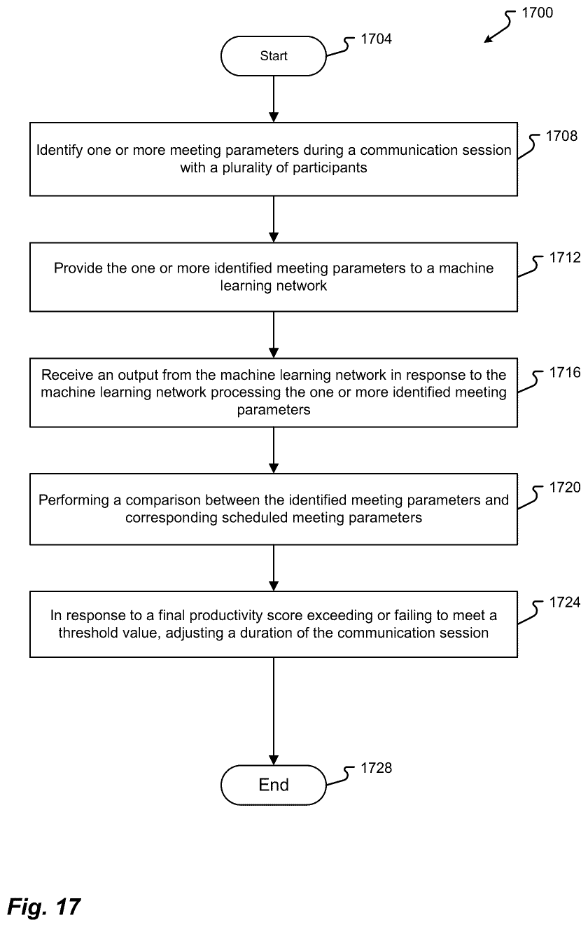

FIG. 17 is a flowchart of an example process for measuring the productivity of communication sessions and using the measured productivity to improve future communication sessions in accordance with at least some embodiments of the present disclosure. While a general order of the steps of method 1700 is shown in FIG. 17, method 1700 can include more or fewer steps or can arrange the order of the steps differently than those shown in FIG. 17. Further, two or more steps may be combined into one step. Generally, method 1700 starts with a START operation at step 1704 and ends with an END operation at step 1728. Method 1700 can be executed as a set of computer-executable instructions executed by a data-processing system and encoded or stored on a computer readable medium. Hereinafter, method 1700 shall be explained with reference to systems, components, modules, software, data structures, user interfaces, etc. described in conjunction with FIGS. 1-14.

Method 1700 may begin at START operation at step 1704 and proceed to step 1708, where the processor 236 of the productivity server 232 identifies one or more meeting parameters during a communication session with a plurality of participants. After identifying one or more meeting parameters during a communication session with a plurality of participants, at step 1708, method 1700 proceeds to step 1712, where the processor 236 of the productivity server 232 provides the one or more identified meeting parameters to a machine learning network. After providing the one or more identified meeting parameters to a machine learning network at step 1712, method 1700 proceeds to step 1716, where the processor 236 of the productivity server 232 receives an output from the machine learning network in response to the machine learning network processing the one or more identified meeting parameters. After receiving an output from the machine learning network in response to the machine learning network processing the one or more identified meeting parameters at step 1716, method 1700 proceeds to step 1720, where the processor 236 of the productivity server 232 determines the output comprises a productivity score generated in real-time for the communication session based on the one or more identified meeting parameters and determines that the output is based on a comparison between the identified meeting parameters and corresponding scheduled meeting parameters. After determining the output comprise a productivity score generated in real-time for the communication session based on the one or more identified meeting parameters and determines that the output is based on a comparison between the identified meeting parameters and corresponding scheduled meeting parameters at step 1720, method 1700 proceeds to step 1724, where the processor 236 of the productivity server 232 in response to a final productivity score exceeding or failing to meet a threshold value, adjusts a duration of the communication session. After in response to a final productivity score exceeding or failing to meet a threshold value and adjusting a duration of the communication session at step 1724, method 1700 ends with END operation at step 1728.

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
identifying, by a processor, one or more meeting parameters during a communication session with a plurality of participants;
providing, by the processor, the one or more identified meeting parameters to a machine learning network;
receiving, by the processor, an output from the machine learning network in response to the machine learning network processing the one or more identified meeting parameters,
wherein the output comprises a productivity score generated in real-time for the communication session based on the one or more identified meeting parameters, and
wherein the output is determined based on a comparison between the identified meeting parameters and corresponding scheduled meeting parameters; and
in response to a final productivity score exceeding or failing to meet a threshold value, adjusting, by the processor, a duration of the communication session.

2. The method of claim 1, wherein the one or more identified meeting parameters are selected from the group consisting of time meeting parameters, location meeting parameters, participant meeting parameters and topic meeting parameters.

3. The method of claim 2, further comprising generating, by the processor, a productivity score for each of the one or more identified meeting parameters, wherein the productivity score is further based on the machine learning network learning from user feedback and tuning the productivity score based on the user feedback.

4. The method of claim 3, further comprising outputting, by the processor, a notification to a user device of one or more of the plurality of participants based on a participant meeting parameter productivity score.

5. The method of claim 1, wherein the output is further determined based on a comparison between the identified meeting parameters and meeting parameters from previous communication sessions.

6. The method of claim 4, wherein the notification includes transmitting a message to the user device of the one or more of the plurality of participants.

7. The method of claim 4, further comprising outputting, by the processor, to the user device of the one or more of the plurality of participants, a graphical user interface representation for the communication session with representations for the plurality of participants based on the participant meeting parameter productivity score.

8. The method of claim 7, further comprising adjusting, by the processor, a size of one or more of the representations for the plurality of participants based on an adjusted participant parameter productivity score.

9. The method of claim 7, further comprising highlighting, by the processor, one or more of the representations for the plurality of participants based on an adjusted participant parameter productivity score.

10. The method of claim 7, further comprising including, by the processor, a visual representation of the participant parameter productivity scores for each of the plurality of participants along with the representations for the plurality of participants.

11. The method of claim 1, further comprising outputting, by the processor, the final productivity score to a user device of one or more of the plurality of participants.

12. The method of claim 11, further comprising outputting, by the processor, a recommendation regarding the communication session along with the productivity score to the user device of one or more of the plurality of participants.

13. The method of claim 1, further comprising dynamically scheduling, by the processor, a subsequent communication session based on the final productivity score failing to meet the threshold value.

14. The method of claim 1, further comprising dynamically adding or deleting, by the processor, participants to a future communication session, based on the final productivity score exceeding or failing to meet a threshold value.

15. A system, comprising:
one or more processors; and
a memory coupled with and readable by the one or more processors having stored therein a set of instructions which, when executed by the one or more processors, causes the one or more processors to generate a productivity score for a communication session by:
identifying one or more meeting parameters during a communication session with a plurality of participants;
providing the one or more identified meeting parameters to a machine learning network;
receiving an output from the machine learning network in response to the machine learning network processing the one or more identified meeting parameters,
wherein the output comprises a productivity score generated in real-time for the communication session based on the one or more identified meeting parameters, and
wherein the output is determined based on a comparison between the identified meeting parameters and corresponding scheduled meeting parameters; and
in response to a final productivity score exceeding or failing to meet a threshold value, adjusting a duration of the communication session.

16. The system of claim 15, wherein the one or more identified meeting parameters are selected from the group consisting of time meeting parameters, location meeting parameters, participant meeting parameters and topic meeting parameters.

17. The system of claim 15, wherein the output is further determined based on a comparison between the identified meeting parameters and meeting parameters from previous communication sessions.

18. A computer-readable storage medium comprising a set of instructions stored therein which, when executed by one or more processors, causes the one or more processors to generate a productivity score for a communication session by:
identifying one or more meeting parameters during a communication session with a plurality of participants;
providing the one or more identified meeting parameters to a machine learning network;
receiving an output from the machine learning network in response to the machine learning network processing the one or more identified meeting parameters,
wherein the output comprises a productivity score generated in real-time for the communication session based on the one or more identified meeting parameters, and
wherein the output is determined based on a comparison between the identified meeting parameters and corresponding scheduled meeting parameters; and
in response to a final productivity score exceeding or failing to meet a threshold value, adjusting a duration of the communication session.

19. The computer-readable storage medium of claim 18, wherein the one or more identified meeting parameters are selected from the group consisting of time meeting parameters, location meeting parameters, participant meeting parameters and topic meeting parameters.

20. The computer-readable storage medium of claim 18, wherein the output is further determined based on a comparison between the identified meeting parameters and meeting parameters from previous communication sessions.
